(19) United States
(12) Patent Application Publication
(10) Pub. No.: US 2014/0025714 A1
(43) Pub. Date: Jan. 23, 2014

(54) Method and Apparatus for Realizing a Dynamically Typed File or Object System Enabling the User to Perform Calculations Over the Properties Associated with the Files or Objects in the System

(71) Applicant: Nick Alex Lieven Reyntjens, Ledeberg (BE)

(72) Inventor: Nick Alex Lieven Reyntjens, Ledeberg (BE)

(21) Appl. No.: 13/736,646

(22) Filed: Jan. 8, 2013

Related U.S. Application Data
(60) Provisional application No. 61/584,271, filed on Jan. 8, 2012.

(51) Int. Cl. G06F 17/30

(52) U.S. Cl. CPC G06F 17/30115
USPC 707/827

(57) ABSTRACT

A dynamically typed file system and method enables a user to perform calculations over the meta information associated with files, documents, or other entities stored in a non-transitory computer readable medium.

This application claims the benefit of provisional U.S. Patent Application Ser. No. 61/584,271 filed Jan. 8, 2012, which is incorporated by reference herein.

### BACKGROUND OF THE INVENTION

1. Field of the Invention

This invention relates to a dynamically typed file system and method that enables a user to perform calculations over the meta information associated with files, documents, or other entities stored in a non-transitory computer readable medium.

More particularly, the invention relates to a system and method that that enables the user to perform calculations over files, documents, programming objects, or other entities arranged in “types,” which are collections of properties that define a set of the files, documents, or other entities. The results of the calculations are output to a display or transmitted from one computer to another in order to provide the user with information concerning the data entities within the type, in addition to information on the type itself, thereby allowing a “user,” whether in the form of a human or another device or application, to view information concerning the content of folders or other “types” without having to take further action.

The calculations performed by the invention enable derivation of selected properties shared by data entities in an “extent,” defined as all of the data entities that share a set of properties or type, such as the files contained in a folder of a conventional file system.

2. Description of Related Art

Information or data concerning a program object or file is known as metadata. Any property of an object or file may be stored as metadata. Examples of metadata include the filename, size, and format. In a conventional file or object storage system, a user must select and open any folders, containers, or other types in which the files or objects are stored in order to view metadata concerning individual files. While it is common when listing files to display at least some of the file properties, and it is possible in some file or object storage systems to perform specific programming operations or configure files or objects in order to aggregate or otherwise manipulate the metadata, manipulation generally requires specialized skills, and the current systems do not permit the results to be viewed from higher levels in a hierarchical representation of the file or object storage system.

### SUMMARY OF THE INVENTION

The invention relates to a system and method that that enables the user to perform calculations over files, documents, programming objects, or other entities arranged in “types.” The term “type” refers to a term of art in the programming field that refers to collections of properties that define a set of the files, documents, or other entities. Folders that contain files are an example of a “type,” with the type consisting of a collection of file properties shared by the files in the folder. However, those skilled in the art will appreciate that the term “type” may more generally be applied to collections of properties associated with files arranged in entities other than folders, as well as to entities other than files.

The calculations performed by the invention enable derivation of selected properties shared by data entities in an “extent,” based on properties of the individual data entities. The term “extent” is another term of art in the programming field, and refers to a group of data entities that share a set of properties, such as the files contained in a folder of a conventional file system. More generally, the term “extent” refers to all data entities that are associated with a particular type. It will be appreciated that the properties of the data entities may be static or dynamically configured.

The concept of performing calculations to derive properties shared by data entities in an “extent” may be understood from the example (which is intended to be non-limiting) in which the data entities are files, the “extent” is all of the files in the folder, and metadata for individual files are aggregated to derive properties of the “type” or folder that contains the files. It will be appreciated, however, that a particular data entity may be included in the respective “extents” of multiple “types.”

FIG. 15 illustrates relationships between the concepts of “types,” “type properties,” and “entity properties,” as used in the present description. Each type is associated with a set of entity properties, and each entity property may be associated with one or more types. In addition, entity properties may be dependent on each other according to the concept of “inheritance,” described in detail below, while the types themselves may have multiple type properties, including aggregations of the entity properties.

In the remainder of this description, the words ‘entity property’ and ‘file property’, and the words ‘type property’ and ‘folder property’ may be interchanged. The same hold true for the word ‘field’ and the word ‘property’.

While the terms “type” and “extent” encompass a wide variety of data entities and associations, the invention is not an abstract algorithm or idea, but rather a practical application involving a system and method of storing data or files and of manipulating information about the stored data or files that provides the user with information about the stored files in a way that shortcuts the restrictions normally present in a hierarchical file system. The invention ultimately involves input by a user of meta information and procedures for manipulating the meta information in a way that is meaningful to the user, and displaying the results of the calculations. As such, the invention requires at least an input device, a data storage device and a computer-readable medium, a data processing device for performing the calculations, and an output device that either controls a display or that provides output data that can be communicated over a network or other communications medium to a display device. The invention may be applied both to an individual computing system and also to client-server architectures.

In the case of files and folders, the invention allows a user to create a hierarchy of various types of folder and associate various types of fields with these folders. The user can create a folder that will contain the user's files. For each folder the user can specify which properties that folder has. The values of properties may be calculated or inputted by the user. There are two main categories of properties: File Properties and Folder properties. Each file contained in the folder will have its own value for each file property of that folder, file properties are associated with a file. Folder properties only have one value, and they are associated with the folder itself.

According to one preferred embodiment of the invention, a data system includes at least one type stored in a computer readable storage, in which:
the type includes associated properties consisting of entity properties and type properties,
the type has a value for each of the associated type properties and
the type further includes an associated extent, the associated extent consisting of a set of all data entities which are an instance of the type, and in which, by way of example and not limitation:
the type may be a folder,
the data entities may be files, and
the extent may be a set of files associated with the folder, or:
the type may be an object base programming structure,
the data entities may be instances of the object based programming structure, and
the extent may be the set of instances associated with the object based programming structure.

According to this preferred embodiment, each of the data entities of the extent have a value for each entity property associated with said type, and the data system further includes a calculating device configured to:
derive the values of the associated properties by a property calculation based on the values of other associated properties and
derive the set of all data entities of said extent by an extent calculation,

wherein the data entities have an associated set of extents to which they belong. In order to implement this embodiment of the invention, the data system will include a display device and an input device, at least one of types preferably having an associated set of child types forming a hierarchy, and the display device being configured to display the hierarchy and allow a user to navigate through said hierarchy in order to select a type.

In one preferred implementation, the calculating device is formed as a collaborative system including a plurality of computing nodes connected by means of a communication network, such that the computing nodes form a server and client architecture with a server and one or more clients, the computing nodes each functioning as a client that includes output device, and changes to the values of said associated properties lead to the server sending notifications to a subset of all clients connected to the server so that the clients may alter the output of their output device in response to said notifications.

At least one of the clients may preferably include an input device configured to at least enable modifications of the associated properties of a type, the modifications including:
altering the property calculation of one of said associated entity properties followed by
altering the extent calculation of one of said types
   with the server being configured to process said modifications of said associated properties originating from said client.

Alternatively, the calculating device of the preferred embodiment may be formed as a standalone system that includes a single computing node including an output device, wherein changes to the values of said associated properties lead to the standalone system altering the output of its output device. The standalone system may further include an input device and a display device of the standalone system may be configured to:
display the type;
display the data entities in the extent of said type upon selection of said displayed type through said input device; and
display the values for a subset of said associated entity properties of a displayed data entity upon selection of the displayed data entity, the display device possibly being further configured to modify the display state of the displayed associated entity properties of the displayed data entity as a function of the extents of which said displayed data entity is part of.

The associated set of extents to which a data entity belongs may be calculated by extent calculations such as set operations: unioning, intersecting, complementing or XORing. Additionally filtering based on a comparative evaluation of a test value, the test value being consulted for each data entity of at least one other extent and additionally the test value being the value of at least on entity property of these data entities. Also, the associated set of extents may change over the lifetime of the data entity.

According to one particular embodiment, the result of the comparative evaluation may be the result of comparing the test value against another associated entity property or alternatively against a type property of the corresponding type or alternatively against a constant. According to one particular embodiment the results of this comparative evaluation may be stored in an entity property, for example by means of a boolean value.

The value of entity properties may be calculated by property calculations such as summation, subtraction, division or multiplication. Alternatively, the property calculations for type properties further may further include aggregation calculations, and be performed on all values of an associated entity property of all data entities of the extent of said type.

The type may inherit the entity properties of another type, according to the concept of inheritance explained in more detail below.

The calculating device may be further configured to automatically recalculate:
property calculations in response to a change in said values of other associated properties;
extent calculations in response to a change in said test values; and
extent calculations in response to a change in said at least one other extent

The data entity may be part of the extent of a first type having a first associated entity property deriving its value by means of a first property calculation, and also part of the extent of a second type, the second type inheriting the first associated entity property from said first type, with the second type overriding the first property calculation by a different second property calculation such that when said data entity is part of the extent of second type, the value of said first property of said data entity is calculated by said second property calculation. The inheriting of properties is known as inheritance. When properties are overridden, this gives rise to polymorphism, as generally known to a person skilled in the art.

According to another aspect of this preferred embodiment of the invention; the available operations of the extent calculations include at least the union and intersection of one or more other extents, the available operations of the aggregation calculations include at least calculating the minimum, maximum and summation of said values; and the available operations of said property calculations for said associated entity properties further include at least smaller than, bigger than and equal to.

In other preferred embodiments, the invention may be applied to an object-oriented development system for creating a computer program, and to a method for automatically updating the values of derived properties in a data system.

Additional aspects of the invention may be understood from the following description of the preferred embodiments, and the accompanying drawings, in which:

### BRIEF DESCRIPTION OF THE DRAWINGS

FIG. 1 illustrates a user interface constructed according to the principles of a preferred embodiment of the invention.

FIG. 2 is a schematic diagram of a system for implementing the user interface of FIG. 1.

FIG. 3 is a schematic diagram illustrating a client/server architecture for the system of FIG. 2.

FIG. 4 is a schematic diagram illustrating inheritance and push-in relationships that may be used by preferred embodiments of the present invention.

FIG. 5 is a schematic diagram of a data structure that may be used in preferred embodiments of the present invention.

FIG. 6 is a flow diagram illustrating the manner in which files of a folder may be calculated in preferred embodiments of the present invention.

FIG. 7 is a dependency graph of properties, entity properties and type properties, that may be used in the preferred embodiments.

FIG. 8 is a flow diagram illustrating an embodiment of how a topological ordering of the dependency graph of FIG. 7 can be calculated.

FIGS. 9-14 are flow diagrams illustrating processing that may be used for updating and propagating updated values in the preferred embodiments.

FIG. 15 is a schematic diagram that illustrates the concepts of “types” as used in connection with the system and method of the present invention.

### DETAILED DESCRIPTION OF THE PREFERRED EMBODIMENTS

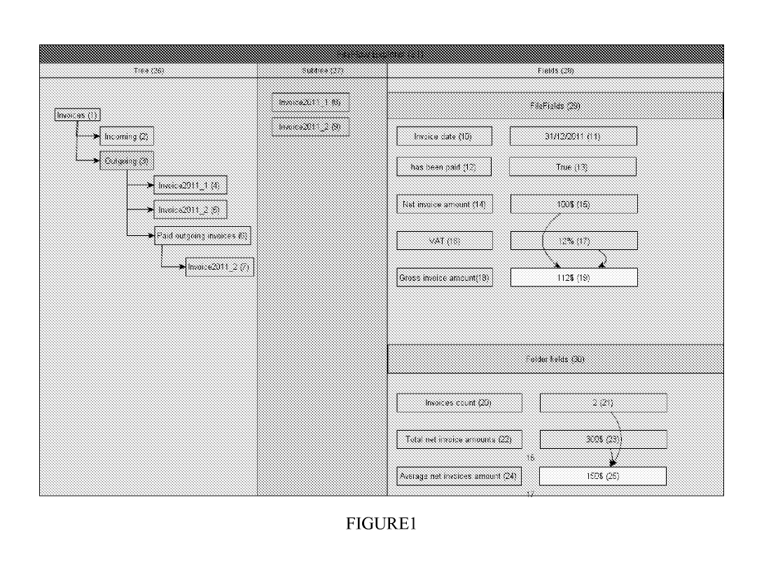

User Interface/File System Example (FIG. 1)

FIG. 1 is a screen shot of a user interface display that illustrates principles of a preferred embodiment of the invention. The user interface displays a hierarchy of folders, shown in a tree section (26), that includes a main folder ‘Invoices’ (1) and two main subdivisions of the main folder, labelled ‘Incoming’ (2) and ‘Outgoing’ (3). Although the user interface is illustrated as including a hierarchy of folders arranged as trees, it will be appreciated by those skilled in the art that the exact layout of the user interface may be varied without departing from the scope of the invention. For example, the illustrated sub trees may be replaced by tables that show the values of the properties directly.

As shown in FIG. 1, the ‘Outgoing’ folder has been selected, and as a result, the files invoice2011_1 (8) and invoice2011_2 (9) included in the ‘Outgoing’ folder are shown in the sub tree (27) section. The user interface of this example also displays the files in the tree section (26), which is why the files are repeated there ((4) and (5)). The ‘Outgoing’ folder (3) has a sub folder named ‘paid outgoing invoices’ (6) that also contains the Invoice2011_2 file.

In this example, the fields of the selected folder are displayed in a fields section (28), containing a subsection for the file fields (29) and the folder fields (30). The values of the file fields are shown for the selected file (9) in the sub tree section (27). For each of the main facts one would like to know about an invoice, a field has been created. These fields are; ‘Invoice data’ (10), ‘Has been paid’ (12), ‘Net invoice amount’ (14), VAT (16) and ‘Gross invoice amount’ (18). The value for the property ‘Gross invoice amount’ (19) is calculated from the values of the properties ‘Net invoice amount’ (15) and VAT (17). The expression used to calculate the value of the property ‘Gross invoice amount’ (19) is not shown but would be something like ‘=[Net invoice amount]+[Net invoice amount]*[VAT]’.

Further, as illustrated in FIG. 1, the selected folder has three folder properties; ‘Invoices count’ (20), ‘Total net invoice amount’ (22) and ‘Average net invoices amount’ (24). The value of the folder property ‘Average net invoices amount’ (25) is calculated from the values of the two other folders properties ((21) and (23)). In addition, the value of the ‘Total net invoice amount’ properties is calculated from the values of the ‘net invoice amount’ property values of all the files contained in the ‘Outgoing’ (3) folder. The ‘Total net invoice amount’ property is an aggregate property, with the aggregation function in this example being ‘sum.’ For the illustrated values of the respective files, the value of the property ‘Net invoice amount’ (14) for the file (8) would be ‘200.’

The content of the ‘paid outgoing invoices’ (6) is calculated from the content of the ‘Outgoing’ folder. In this example the ‘paid outgoing invoices’ folder has as a source or ‘push-in’ folder the folder ‘Outgoing’ and its condition is ‘Has been paid’ equals ‘True’. In other words, the reason that the ‘Outgoing’ folder contains the file Invoice2011_2 (7) is because the value of the field ‘has been paid’ (9) is true for that file, ‘has been paid’ is the result of the comparative evaluation of a test value. This is an example of an extent calculation, because the extent of ‘paid outgoing invoices’ (6) is being calculated.

Those skilled in the art will appreciate that these mechanisms together result in a system where each file is dynamically associated with a set of ‘types,’ which in this case are the folders to which the file belongs, the types associating properties with the file. This assignment of types to a certain file is dynamic and may change over the lifetime of the file. In addition, a file may be seen as an object, and thus the invention may be characterized as either a “file” or “object” system.

Similar to conventional file systems, files in the illustrated embodiment can be copied, added to, and removed from a folder, as well as being deleted, moved, or associated with a link that can also be copied, moved and added to and removed from a folder. In addition, folders can be moved, copied, created and deleted, and some embodiments may also allow creation of links to folders. Finally, properties can also be moved, copied and deleted.

A file property may have an expression and it may be overridable. The value of a file property is calculated from its expression. When the file property has no expression, then it has no value, unless the user has supplied one by overriding the calculated value. Through data validation, it may be made mandatory for the user to supply a value. The user may also override the calculated value if the property is overridable.

A folder property can also have an expression, this expression configuring the extent calculation, and be overridable, similar to a file property. Each aggregated folder property has an aggregation type: sum, minimum, maximum . . . or any other function that reduces a plurality of numbers to one number, and a file property over which the folder property will aggregate. Additionally it may also be overridable.

File properties may reference all file properties of the same folder in their expressions. They may also reference all folder properties of all folders from their expressions. Folder properties may also reference all folder properties of all folders in their expressions. Additionally, aggregated folder properties may reference a file property associated with the folder.

By way of example and not limitation, the kinds of folders may include factual, calculated and factual-calculated folders.

Factual folders may also be called material, while similarly calculated folders may also be called immaterial. A calculated folder can be seen as a predicate over all files in the system. In the illustrated embodiment, the user can specify the source folders (also called push-in folders) of a calculated folder, a method to combine the contents of those push-in folders, such as ‘and,’ ‘or,’ exclusive ‘or’ (XOR), or complement, and a file field that will be used to as a condition to filter the set obtained after the combination step. Alternatively, this could also be realized by a formula.

A material folder is a folder where the containment of files cannot be derived from other facts, i.e., as in a conventional folder in a conventional file system, the containment is not calculated. However, the content of material folders may still be augmented by push-in relations if the folder is factual-calculated.

It will be appreciated that the illustrated embodiment is one of multiple possible ways to realise the concept of calculated folders. However, although other embodiments may digress in how exactly calculated folders are calculated, such embodiments will still generally need to make the distinction between calculated and not-calculated (material/factual) folders.

For example, a folder may also be seen as a boolean file property (without expression and overridable) that all files in the system have (see also the set and boolean duality principle). The user may reference this file property in expressions similar to those used to reference conventional file properties.

Also, in an exemplary embodiment, each file in the system has a name, a description, and optionally an image, which are in addition to the content of the file itself and which may be any piece of information that can be represented by a sequence of bytes. The name is used when listing files or referring to one file, together with the optional image.

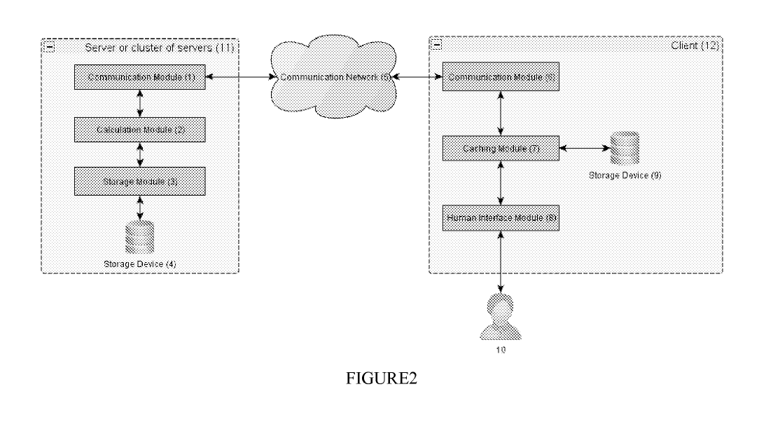

Hardware-Client/Server Implementation (FIG. 2)

A system made up of hardware components for implementing the above-described file system and corresponding user interface will now be described:

FIG. 2 depicts a server (11) and a client (12) linked through a communication network, together with corresponding modules. Those skilled in the art will appreciate that the term ‘storage device’ encompasses any piece of hardware capable of remembering data for an amount of time, including but not limited to a hard disk, a RAM memory, and flash disks. In addition, it will be appreciated that any implementation or embodiment may have more modules than depicted in FIG. 2, which only depicts one client and one server, but which in reality would likely include a plurality of clients and servers.

The server (11) contains a communication module (1), a calculation module (2), a storage module (3) and finally a storage device (4). The client (12) contains a communication module (6). Optionally, the client (12) will have a caching module (7), in which case the caching module will also have a storage device (9). The client may also have a human interface module (8), allowing a human to interact with the system.

The client and server communication modules handle communications between the client and server. This may be, but is no required to be, handled by modules implemented by programmed computing or processing devices on both sides. On the server side the calculation module (2) updates properties in response to external or internal update commands to the server, such as time elapsing. The values of the properties are stored in a storage device (4) by means of a storage module (3).

On the client side, the optional caching module (7) caches data once requested from the server and stores that data in its own storage device (9). The caching module may internally contain a storage module to facilitate this task. Different embodiments may apply different caching techniques, since many such techniques are well known to those skilled in the art.

One example of a caching technique is a technique in which the client always requests data from the server through the cache, and if the data is present in the cache then the cache sends a data version request to the server and the server replies with the current version of the data. If the version is the same as the version of the data in cache, the cached data is returned to the client. If the data is not in the cache or the version in cache is outdated, the data is requested from the server and stored again in the cache, together with its newer version.

Concretized to a file content request, the last example becomes: the client requests the content of a file, and the cache module checks if the file is in the cache. If not, then the file content is requested from the server. If the file is in the cache, then the current version of the file content is requested from the server and checked, possibly still resulting in a request for the content of the file from the server. When the content of the file from the server is received, it is saved in the cache together with its version so it can be retrieved faster in the future. Finally, the file content is returned to the client. In a preferred embodiment, the difference between the version in the cache and the version on the server may be exchanged between the client and the server, so that the entire file does not need to be exchanged.

Having described hardware for implementing the file system of the preferred embodiment, it will be appreciated that the hardware may be varied by integrating or distributing the modules between devices, and further that the connections between the client and server may be arranged in a variety of ways.

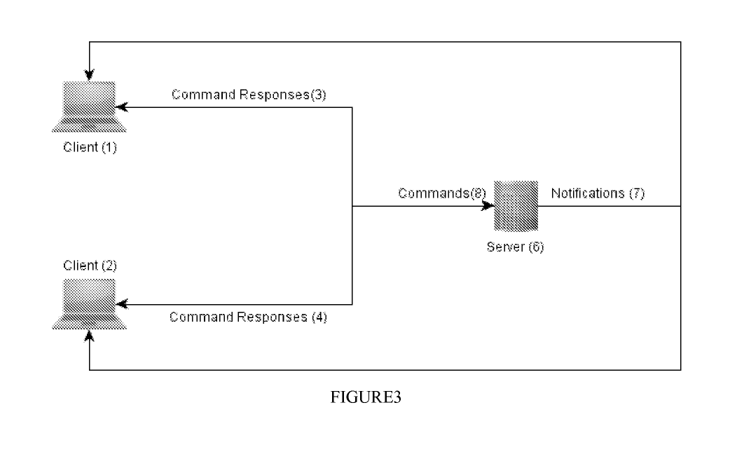

For example, in the embodiment the invention implemented by the architecture set forth in FIG. 3, clients ((1) and (2)) and a server (6) are able to communicate through a communication medium. As illustrated in this figure, only two clients are depicted although there may in reality be more than two clients. In addition, one server is depicted, but in reality there may be many servers working together. The server should therefore be seen representing the serving part of the system rather than as a literal server unit. Both commands and notifications are considered to be messages.

The clients send commands to the server (8). Some of these commands are requests for data, for instance to retrieve the files in a folder, or to retrieve the data of a certain file. These types of commands are called data request commands. In response to data request commands, the server replies with an appropriate command response (3) containing the requested data, or a reason why the requested data could not be delivered. Those skilled in the art will appreciate that the BLOB data of a file may be transferred by a protocol (e.g., ftp, named pipes, torrents) and medium that is separate from the protocol and medium used for other kinds of data. Thus, although FIG. 3 identifies the direction of the streams of data through the system, it should be understood that different kinds of messages/command may be delivered by different means.

Other commands may instruct the server to update some fields of a file, or to create some new folder. These last commands are called update commands. The server may also send back a command response (3) to the client, with information about the execution of the update command, for instance whether the update was successful or why the update was not successful.

In one embodiment, the server sends back notifications (7) to the clients to inform them that an event has occurred that may be of interest to the client. Such an event may be that some data on the server has changed, and the client may use this information to, for instance, update a display screen so that the user always sees the latest data, or alternatively to maintain a mirror of the server data, update its cache, or any of a variety of other reasons, such as to simply inform the user that some data has changed.

Certain embodiments may choose to filter the notifications that are sent to the clients on a per client basis. The clients may, for instance, have to show interest in a certain piece of data before they will receive notifications about it. This may be accomplished by allowing the client to register himself as an observer of certain subsets of the data in the store of the server. The server will then only send notifications to clients who are observer of a subset of the data in the store, if a part of that subset of data has been changed. Optionally, when a client does a request for a subset of the data, the request may implicitly register the client as an observer of the subset of data.

Finally, with respect to FIG. 3, those skilled in the art will appreciate that different embodiments may provide different granularities for which data can be requested or be observed. A client may, for instance, request the value of one property of a file, or request the value of a property for all files in a certain folder, and that the same considerations may also be applied to registering as an observer of a subset of the data.

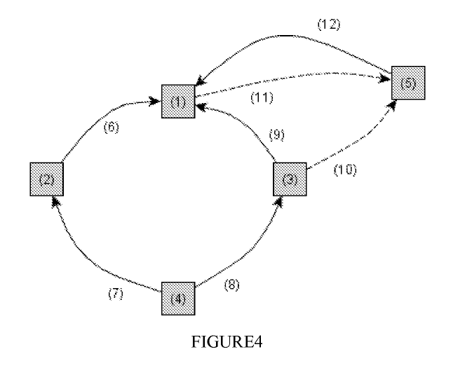

### Inheritance and Push-In Relationships (FIG. 4)

The concepts of ‘inheritance’ and ‘push-in’ relationships will now be described in connection with FIG. 4:

Folders can engage in at least two types of relationships: inheritance relationships and push-in relationships. FIG. 4 illustrates 5 folders ((1), (2), (3), (4) and (5)) that have inheritance relationships (the black arrows) and push-in relationships (the dotted arrows). For example, folder (3) inherits from folder (1) and folder (1) pushes into folder (5). The inheritance relationship (12) may in some embodiments be implied from the push-in relationship (11).

When a folder inherits from another folder, it inherits all file properties, but folder properties are not inherited. The concept of inheriting instance fields is known and has been applied in many programming languages, and may be understood from the following example: Suppose we have 2 folders, folder A and folder B. Now suppose that folder A has three file properties a1, a2 and a3 and two folder properties a4 and a5. Further suppose that folder B has two file properties b1 and b2. Now, if folder B were to inherit from folder A, folder B would now have five file properties, including b1 and b2 and three inherited properties a1, a2 and a3. Properties b1 and b2 are the declared file properties, while properties a1, a2 and a3 are the inherited properties and the inherited file properties together with the declared file properties are the file properties of the folder B. This also implies that file properties b1 and b2 may also reference the properties a1, a2, and a3 and that folder B may have aggregate properties that aggregate over properties a1, a2, a3, b1 and b2 of all files contained in folder B. A folder may inherit from multiple folders and may be inherited from by multiple folders.

When folder A is said to ‘push into’ folder B, the term ‘push into’ means that a subset of the files contained by folder A will also be contained by folder B. We may also say that folder A is a source folder of folder B, or that A is a calculation source folder of B, or that folder A is used in the extent calculation of folder B. In other words, folder B's set of files gets augmented by a subset of the files in folder A. A folder A may push into another folder B unconditionally, in which case folder B's files will be augmented by all files in A. Also, a folder may push into multiple folders and may be pushed into from multiple folders.

The user can independently manage the inheritance relationships and the push-in relationships. For example, in one embodiment, push-in relationships may imply inheritance relationships in the following way: When it can be proven by reasoning that all files in a folder will always have all properties of another folder, possibly as a consequence of a push-in relationship, that folder may implicitly inherit from the other folder, so that when folder A pushes unconditionally into another folder B, folder A implicitly inherits from folder B. In that case, to use a simple example, ‘Or’ and ‘XOR’ and ‘Difference’ folders would implicitly inherit from the common inheritance ancestors of their push-in folders, and any ‘And’ folders would implicitly inherit from all their push-in folders.

In another embodiment, either the push-in relationships or the inheritance relationships may form a directed graph that is not allowed to have cycles, while is a still further embodiment, cycles may be allowed in inheritance relationships and having a cyclic relationship would then mean that each folder that is part of the cycle will have the same properties, i.e., the union of their individual properties. In another embodiment, cycles may be allowed in unconditional push-in relationships and having a cyclic relationship would then mean that each folder that is part of the cycle will have the same files, namely the union of all their individual files.

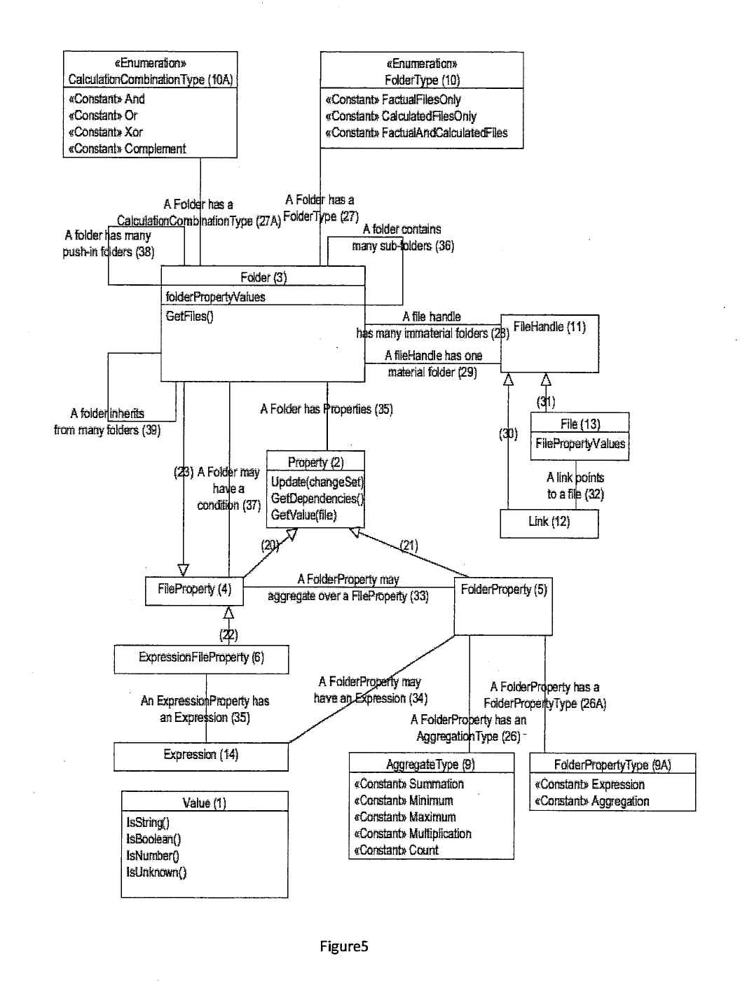

### Data Structure (FIG. 5)

In order to easily work with files and folders in order to implement a file system, or alternatively an object oriented system, such as the one illustrated in FIG. 1, an adequate computer data structure is needed. FIG. 5 presents one possible data structure that may be used. The data structure is represented in an UML diagram that can be easily understood by a person skilled in the art.

The most prominent classes are Property (class 2), Folder (class 3) and FileHandle (class 11). A Folder has defined Properties (association 35) and contains FileHandles (association 28 and 29). A Folder also contains sub folders (association 36), similar to a conventional file system, inherits from many Folders (association 39), and can be asked for its properties, which will be the union of its defined properties and its inherited properties. As illustrated, a Folder may have many push-in Folders (38), and a conditional boolean FileProperty known as the post calculation filter (association 37), which embodies the result of the comparative evaluation of the test value used in its extent calculation. Folders are of a certain FolderType (enum 10) (association 27) that may change during its lifetime. Folders also have a CalculationCombinationType (enum 10) (association 27A) that will be used if the folder is of FolderType CalculatedFilesOnly or CalculatedAndFactualFiles when combining the files in the source folders as part of the calculation of the calculated files. Finally, in the illustrated example, a Folder may store the values of its FolderProperties (5).

Files (13) and Links (12) are both FileHandles (inheritance relations 30 and 31). A Link contains a reference to a File (relation 32). Most code operates on objects of type FileHandle and thus is indifferent to the fact that the object is a File or a Link. A File stores the values of its file properties while a Folder stores the values of its folder properties.

There exist two main types of Properties: FileProperties (class 4) and FolderProperties (class 5). Properties have three main operations: 1) they can be asked (through invoking methods on them) for a value given a certain file (when asking folder properties for a value the file argument is ignored); 2) they can be asked for all properties on which they are dependent; and 3) they can be asked to update the current change set during a recalculation cycle (more explanation on points 2 and 3 will be given in following the sections).

Normal FileProperties are of the type ExpressionFileProperty (class 6) (inheritance relation 22). An ExpressionFileProperty contains an Expression (14) (association 35). An Expression represents an expression entered by the user (e.g. ‘=(+A B)’). See below for a description of a suitable expression language.

The other type of FileProperty is a Folder (inheritance relation 23), which may be modelled as a FileProperty with a boolean value. This makes sense because of the duality between set containment and a boolean property on the elements that may be contained in the set, as explained below. A file (the element) may be contained in a folder (the) set. This folder itself is the boolean property that represents the containment in the folder. Consequently, just as the value of an ExpressionFileProperty for a file is calculated from the values of other file properties of the same file and folder properties, the fact that a file is contained in a folder is calculated based on the values of other file properties of that file and folder properties. How the content of folders is calculated is explained in more detail in a following section.

FolderProperties are of a certain FolderPropertyType (enum 9A) (association 26A) that may change during its lifetime, either Expression or Aggregate. To mark a FolderProperty as being of a certain FolderPropertyType, one may use the notations ExpressionFolderProperty and AggregationFolderProperty, respectively, for the types Expression and Aggregation. ExpressionFolderProperties contain an Expression similar to FileExpressionProperties (association 34) but, in contradiction, the FileExpressionProperties, ExpressionFolderProperties may not reference FileProperties, and may only reference all other FolderProperties, including those of other Folders.

AggregateFolderProperties perform an aggregation over a FileProperties (33) of the files contained in their folder. AggregateFolderProperties are of a certain AggregateType (enum 9) (association 26) that may change during its lifetime. This allows the user to, for instance, sum all invoice amounts of all invoice files in the Folder ‘urgent invoice’. Here the folder ‘urgent invoice’ could have the FileProperty ‘invoice amount’ and the folder would also have the AggregateFolderProperty ‘sum of invoice amounts’ that would be of type Sum.

A FileHandle has one material Folder (relation 29) and many immaterial folders (28). The immaterial folders are Folders where the FileHandle is contained in an immaterial way. This will be further explained in a following section.

In some embodiments, properties may also be of a certain type, such as string, number or boolean. Such embodiments may validate the expressions so that the types of the arguments fit those expected by the called function. Folder membership properties are then of the type boolean.

The class Value (class 1) represents a value and is used by the system to perform calculations. Values can be added, multiplied and perform all other operations that can be performed with strings, numbers or booleans, but when they perform these calculations they hold into account that one of the inputs of the calculation may be a value that is unknown. In that case, the result may also be unknown. For example adding a known value and an unknown value will result in an unknown value. Unknown values are used when the system cannot known the value of a property; perhaps because the user has not supplied one, or because some operation was invalid (such as taking the square root of −1). All code that performs operations with values (Expressions and AggreagateProperties) are indifferent to the fact that a value may not be known. They simply perform operation on objects of type Value.

Lastly, it will be appreciated that additional folder and aggregation types can easily be added. Additional aggregation types can also be easily added.

In the above-described embodiments, the persistence of the system could be handled in many ways. For example, an easy way to make the system persistent is to use an object oriented database and, in the illustrated embodiment, all objects may simply be serialized. However, a custom object oriented database could also be written, possibly starting from an open source, well documented implementation such as Perst (from McObject) or db4o. Alternatively, the data may be persisted in a relational database, possibly by using an ORM (such as hibernate or entity framework). The files, values of type properties and values of file properties, which form the data set, could be stored in a different system than the model data, which includes structural information of the Folders and Properties. Additionally the bytes contained in files may be stored in yet another data storage. Such an external storage device could be a conventional file system. Those skilled in the art will appreciate that most persistence solutions also make the system transactional, multi-user, distributed and high available. How to leverage these features can be found in their documentation and is commonly known in the prior art.

### Expression Language

The manner in which the calculations are expressed to enable calculations over the properties associated with files (or objects) will now be described in detail:

In order for the user to express the calculations that need to be done by the various calculated properties, an expression language may be introduced. The language denotes functions and the arguments on which they operate. A purely illustrative example might be: “if((A+B+C)*D>2, A, B),” where A, B, C and D are other file fields or folder fields.

All mathematically known functions may be made available including, but not limited to, Minus, Sum, Divided, Multiply, Modulo, Max, Min, Sin, Cos, Tan, If then else, switch, Faculty, Exp, Logarithm, Sqrt, . . . . and so on, as well as mathematically functions provided through third party application programming interfaces (API's). The arguments to which the functions apply may result from the application of other functions (leading to nested function applications), may refer to other file fields of the same file or folder fields from any folder, or may be constants.

The language that is used may be infix or postfix (e.g. “(A+B+B)” or “(+A B C)”), and it may name functions explicitly or explicitly (e.g., “(+A B)” or “(sum A B)”). IN addition, the language may use any delimiting symbols to specify the order of evaluation (e.g. “((A+B)/C)” or “[[A+B]/C]”).

The names of properties may be quoted and they may be prefixed by the name of the folder. Additionally the properties of a folder may also be inside some name space mechanism, which is a common practise in the computer science arts, in which case the properties of the folder may look even more like a programming language ‘IF A>B THEN 1 ELSE 2’.

Those skilled in the art will appreciate that the invention is not to be limited to a particular notation, and that any notation that might be useful can be included. What matters is the functions that are supported and to where the arguments of those function may refer. The function arguments used in the expressions of calculated file fields may refer to any other file field of that folder and any folder field in the system. In addition, the function arguments may be extended to allow file fields to reference all other file fields and to let the value of a file field that is currently not present for a file to have a default value, null, or unknown, in which case the function arguments might include a function that allows discovery of whether a file property is present (e.g. ‘IF HASPROPERTY(Age) THEN Age ELSE 20’ or ‘IF Age==NULL Then 20 ELSE AGE’). Calculated folder fields may only refer to any other folder fields in the system. Aggregated folder field are special and will have a more limited language, but may refer to any file field of the folder.

File properties may reference other file properties of the same folder and all folder properties known to the system. Additionally, it is possible to also refer to all folders' membership properties, in which case each folder member property's name could be derived from the name of the folder so that it may be used in expressions. In the example illustrated in FIG. 1, for example, the folder ‘Invoices’ may be referenced from expressions by the name ‘InInvoices.’ This allows expression file properties to alter their behaviour based on whether a file is in a certain folder or not (e.g., ‘=(IF Inlnvoices THEN (+A B) ELSE (*A B))’ where Invoice is the name of a folder).

In addition to file properties that reference other file properties, there may be default file properties such as ‘lastModified’ and ‘SizeInBytes’ and so on, as well as artificial folder properties that represent external elements to the system, such as the current time, the name of the current user, the operating system, geographic location of the system, and so on. The artificial folder properties may also take arguments that alter their behaviour. For example: A file property ‘IsUrgent’ may be defined in the folder ‘Invoices’ that would identify invoices that urgently need to be paid by subtracting their ‘ToBePaidPayedDate’ from the current date and stating that the difference should be smaller than 5. This may be expressed as ‘((−ToBePaidPayedDate (Time granularity:day))<5)’ (here ‘day’ is an argument ‘granularity’ of property Time). The system would than check the value of this property on a daily basis and take appropriate action when the value changes, such as add the file to a folder named ‘UrgentInvoices’ and possibly send an email because the file has been added to the ‘UrgentInvoices’ folder and that folder had an email action defined on its ‘OnFileAddedEvent’. The concept of actions will be described in more detail below in connection with ‘extensions.’

In some embodiments, expressions and properties could be typed (as in a typed programming language), requiring a compiler that does type inference to validate the expressions entered by the user in a manner similar to typed computer languages.

Although the illustrated embodiment does not permit cyclic references between fields, it is within the scope of the invention to permit such cyclic references, in which case the cyclic references are evaluated in a special way by for example basing a stop criteria for the update mechanism on the number of iterations, the amount of change of the number, or a combination thereof, similarly to the use of stop criteria in spreadsheets.

Finally, in addition to the above-described language for the expressions, a language may be introduced that is capable of representing each concept in the system (folders, properties and their relations) and may optionally add extra functionality through custom code that integrates with the system.

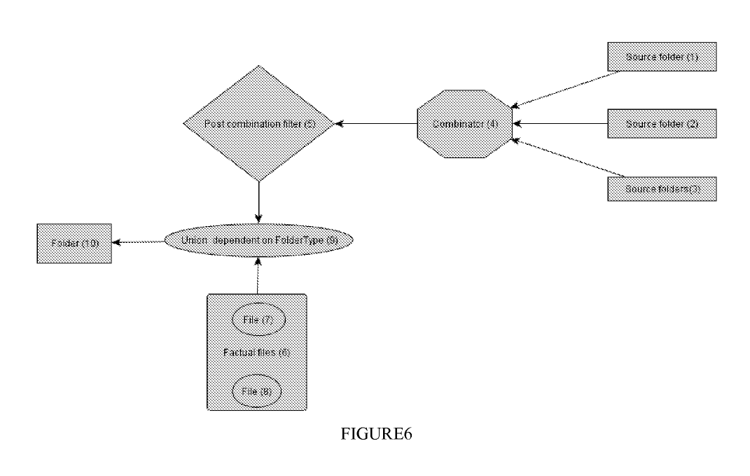

Content of a Folder (FIG. 6)

A folder maintains two sets of file-handles, which may be referred to as material file-handles and immaterial file-handles. Material file-handles are file-handles for which it cannot be deduced that they are present in the folder. They are simply facts that exist because, at some point, a user told the system that a certain file belongs to a certain folder. For instance, when the user moves a file F1 from folder A to folder B, folder B will now contain F1 materially.

Immaterial file-handles are not facts. Instead, the presence of an immaterial file-handle in the folder is deduced from other facts in the system. For instance, in an unconditional push-into relationship it is defined that all files that are present in folder A will also be present in folder B. When the user adds a file Filel to folder A, the file will also appear in folder B because of the push-into relationship, but it is not material—it is deduced from the fact that there exists a push-in relationship (A into B) and that folder A contains file1. From this it follows that the immaterial file-handles set is simply a cache. The system could recalculate the immaterial file-handles each time it needed to list the files present in a folder.

FIG. 6 illustrates exactly how the files of a fictive folder (10) are calculated. First, to calculate the immaterial files, the files in the source folders ((1), (2) and (3)) are combined (4) using the CalculationCombinationType. In this case, ‘Or’ means the union of the files is computed, ‘And’ means the intersection of the files is computer, ‘Xor’ means that those files that appear exactly in one source folder are computed and complement means than all files from the first source folder except the union of all files of the other source folders are computed (it being understood that for all of these combinations a file and a link to a file are considered to be equivalent). After calculating the combination of the files, the resulting set of files is optionally filtered by a post combination filter (5), which is a file property.

The factual files (6) do not have to be calculated (which is why they are factual). In the last step, the factual files are combined with the calculated files based on the type of folder (9) to form the set of file present in a folder. If the folder kind is CalculatedFilesOnly, then the resulting set is the calculated files only. If the folder kind is FactualFilesOnly, then the resulting set is the factual files only. If the type is FactualAndCalcultedFiles, then the resulting set is the union of the calculated and the factual files.

Although an exemplary type algorithm has been described above (and is described in more detail below), it will be appreciated by those skilled in the art that in practice the algorithms for calculating the files of a folder may be optimised by making them more incremental without changing the outcome of the calculations. Furthermore, although a specific calculation example is given, a folder may be considered to simply be a boolean file property as noted above in the “expression” section, and further described below with respect to the calculation engine, and therefore that the invention is not limited to any particular formula, and that additional folder kinds may be freely added without departing from the scope of the current invention.

When the user adds a file to a folder, the user is adding the file to the material set of the folder. In some embodiments, when the user deletes a calculated file from a folder, the user is actually removing the file from the first set of source folders, or possibly even all material sets of all source folders that caused the file to be present in the folder in the first place, so that after this operation, the file no longer appears in the calculated set of files of the folder.

Because the kind of a folder may change during its life time, when a folder goes from being material to immaterial, its set of material file handles is not forgotten. The folders remember the set, so that when they go back to being material, the set of material file-handles includes the same file-handles as before the operation (except for the fact that some files may have been deleted and so forth).

Finally, those skilled in the art will appreciate that the immaterial set of a folder is only calculated in full when any of the meta properties of the folder, such as folder kind, push-in relations or condition, has changed. Otherwise, the set is maintained and files are added and removed in response to changes in the file properties. This will be explained in more detail in the section ‘The calculation algorithm’.

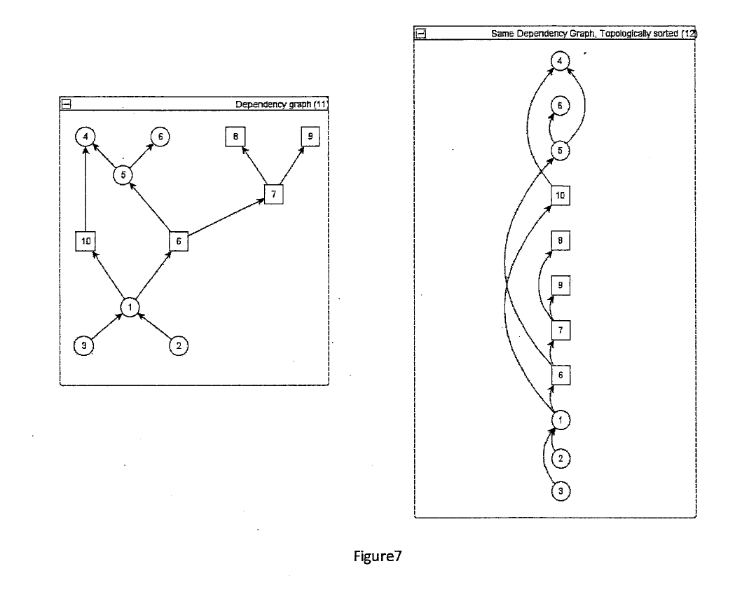

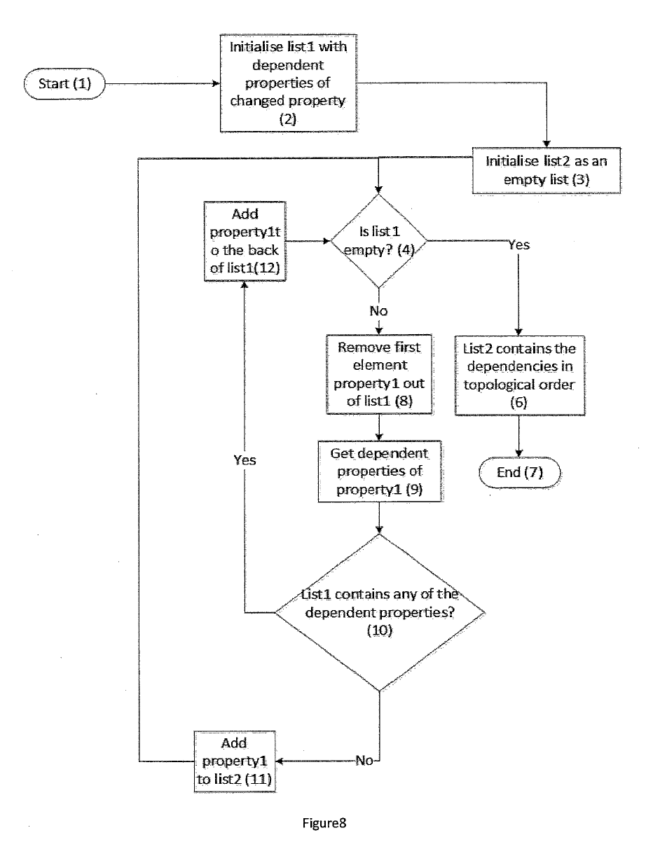

### Folder/File Properties and Dependency Graph (FIGS. 7-8)

The properties of a folder are those defined on the folder itself, augmented with all file properties of all folders from which it inherits. The phrase “property is defined on a folder” therefore means that the user has specified that property to exist on that folder, so that the property is not inherited from any other folder. A description of a folder as having properties, or a description of a folder's properties, refers to all properties of that folder including inherited properties. In some embodiments, push-in relationships may imply inheritance relationships.

To determine the current properties of a file, a determination is first made as to which folders the file (or a link thereto) currently is in. The properties of that file are then the union of all file properties of all those folders. The properties of a link are the same as the properties of the file to which the link links.

According to a particular embodiment, all files may include one or more file properties representing the membership of the particular file that is contained in the set forming the extent of one or more types. This can be realised in two equivalent ways: a boolean or a set data structure, as explained further on.

A property A is dependent on property B when, in order to calculate the value of property A (possibly for a certain file), the value of property B (possibly of a certain file) is required to be used. For example, if there are three file properties; BruttoIncome, WithheldTaxes and Nettolncome, where Nettolncome has an expression ‘=(−Bruttolncome WithheldTaxes)’ and is dependent on BruttoIncome and on WithheldTaxes, it follows that the file properties are dependent on all other file properties in their expression, as well as on the folder or folders (through inheritance) to which it belongs (remember that the folder is also a file property). Those skilled in the art will appreciate that in this example one of those folders may already be dependent on the file property, in which case the folder should not be added to the dependencies of the file property or a cyclic dependency will be introduced. An expression folder property is dependent on all folder properties that it references in its expression. An aggregate property is dependent on the file property that it aggregates and on the folder to which it belongs. A folder (which is also a file property) is dependent on each of its push-in folders and optionally on its condition file property.

FIG. 7 gives an example dependency graph (11) among properties. In this dependency graph, the file properties are represented as circles and the folder properties are represented as squares. When a property depends on another property, an arrow is drawn indicating the dependency. In FIG. 7, property (5) is dependent on properties (4) and (6).

An example topological ordering of that same dependency graph is indicated by reference numeral (12), which shows that when going over the nodes from top to bottom, no node is dependent on a node below it. Because of this trait of the ordering in (12), one can say that the sequence is ‘topologically ordered.’

FIG. 8 illustrates a procedure or algorithm for calculating a topological ordering for a list of dependent properties for a given property, which is utilized by the calculation engine described below. The algorithm starts (1) by initializing a list with the properties that depend on the given property (2). It also initializes a second empty list (3) that will contain the ordered properties when the algorithm is done (6). Then the algorithm enters a loop that does not end until the first list is empty (4). In the body of the loop, the first property of the first list (8) is removed and a check is made as to whether the first property is dependent on any other properties that are still in the first list ((9) and (10)). If it is dependent, then the removed property is added to the back of the first list (12). If there no dependency, then the first property is added back to the second list (11). If the dependency graph contains no cycles, the first list will eventually become empty and the second list will contain the result (6). The algorithm then ends (7).

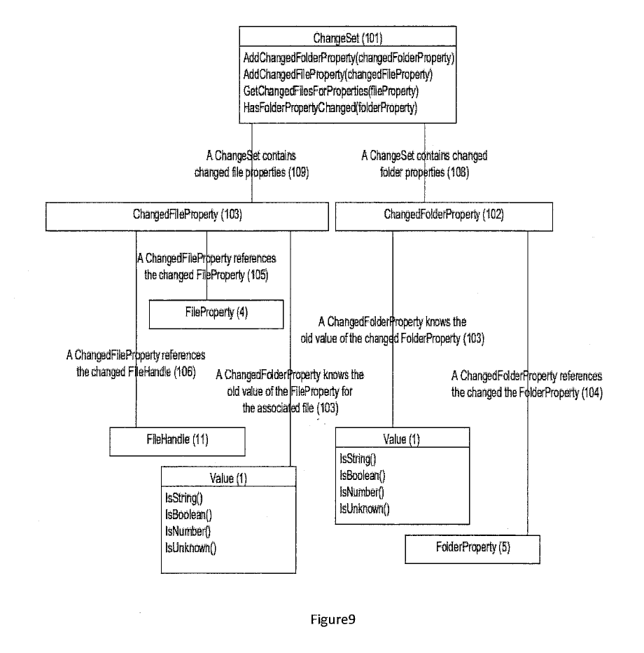

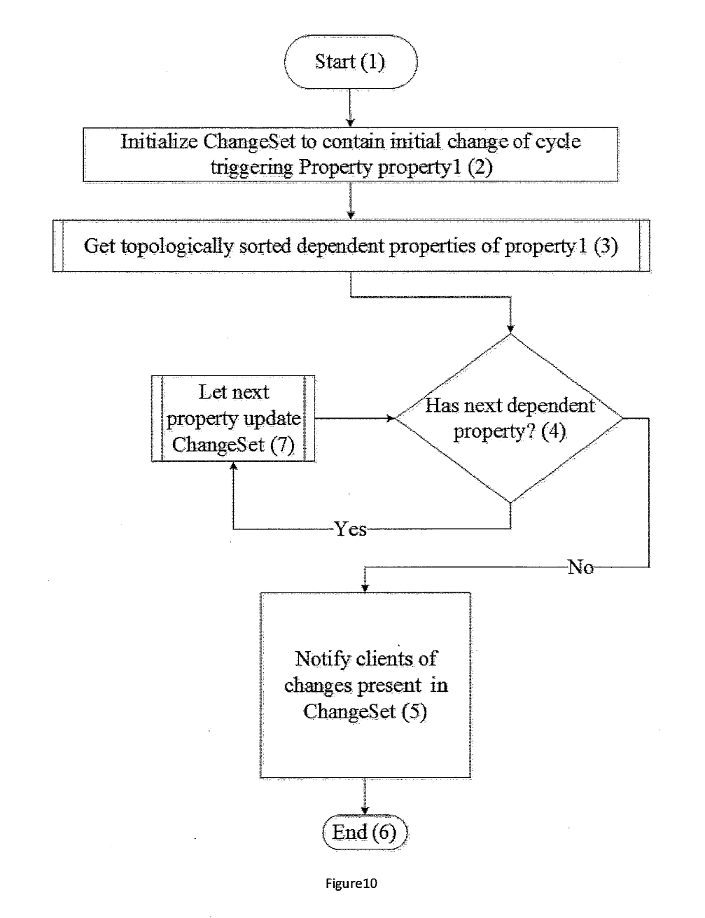

### Propagation of a Value Updated by User (FIGS. 9-10)

The manner in which a value change to a property is propagated to all dependent properties will now be described. In response of an initial update of a property by the user, the system updates all dependent properties in an update cycle. The main flow of the algorithm is this: each property adds changes to a set of changes, based on the changes that are already present in the current set of changes. This is logical if you consider that properties whose value changes imply more properties whose value will change. If there are no cycles this process of values changing will end somewhere. If one can guarantee that all properties on which a property is dependent already has been updated, than the algorithm will end and all dependent properties of the initial property, that needed updating, will have been updated. Updating the properties in topological order guaranties this.

In order to implement the propagation, an object is required that can remember all changes that have already been made at any point during the update cycle. For this one can use the class ChangeSet (101) sown in FIG. 9. The ChangeSet class contains ChangedFolderProperties (102) and ChangedFileProperties (103). These two classes represent changes, so they store all relevant information of the change. The class ChangedFolderProperties stores the FolderProperty (association 104) and the old Value (association 103). Similarly, the class Change/dFileProperty stores the relevant FileProperty (association 105), the old Value (association 107) and also the FileHandle (association 106).

The ChangeSet class thus provides a way to easily add changes, to ask if a FolderProperty has changed, and to get all FileHandles of whom at least one FileProperty in the provided FileProperties has changed.

The topological sorting algorithm, the ChangeSet class and the ‘Update(changeSet)’ and ‘GetDependencies( )’ methods implemented by the Property class can now work together to implement the exemplary update cycle algorithm as illustrated in FIG. 10.

When the algorithm starts (1), it adds the initial change initiated by the user to the ChangeSet (2). Then, all properties that are dependent on the initial property are calculated and topologically ordered (3). Then, the algorithm of FIG. 10 iterates over all those properties (4) and lets each property calculate its changes and update the ChangeSet (7). Properties may also update internal structures while updating the ChangeSet. When all dependent properties have been iterated, the ChangeSet contains all changes done in the model during the update cycle, and can be sent to the clients (5) through notifications. Finally, the algorithm ends (6).

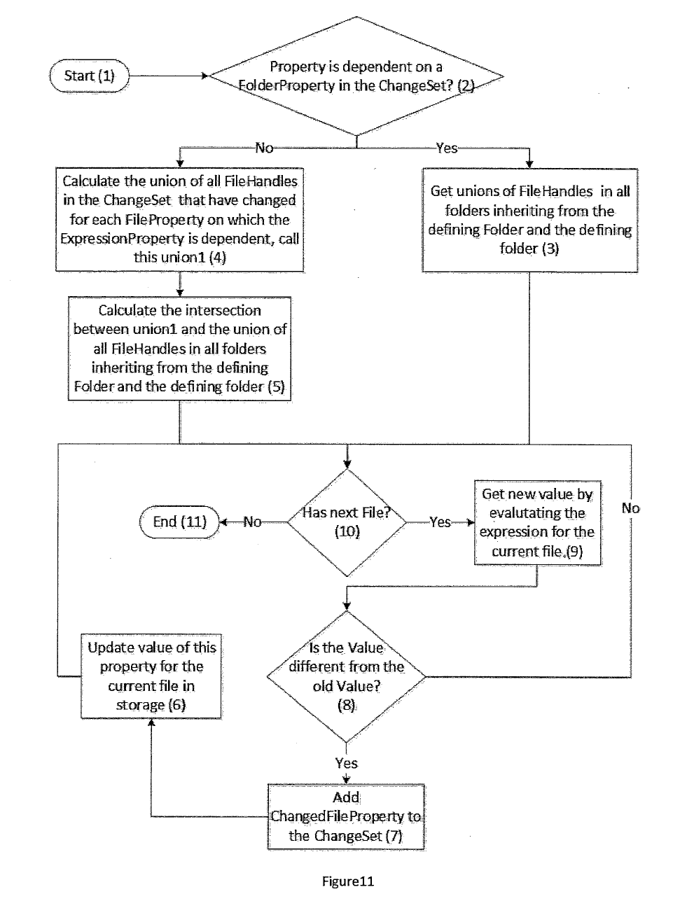

### Calculation of Changes in a Property and Updating of ChangeSet (FIGS. 11-14)

How a property calculates its changes and how it alters the ChangeSet will now be looked at in detail for each Property type:

The algorithm inside the update method of an ExpressionFileProperty is depicted in FIG. 11. When the algorithm starts (1), it checks if there is a FolderProperty that is referenced from its expression that has been changed (2). If there is a FolderProperty reference from its expression that has been changed, then all of the property values are be recalculated for all files of all folders where the property is present (3). Because inheritance relationships do not imply push-in relationships, this is the union of all files from all Folders that inherit from the defining Folder, and the defining Folder itself. If there is no FolderProperty that is referenced from its expression that has been changed (2), then the ChangeSet is asked for all FileHandles for which one of the FileProperties referenced in the Expression has been changed (4). Preferably, in that case, the set of FileHandles is limited to those FileHandles that are present or that were present the previous update cycle in any of the Folders inheriting from the defining Folder and the defining folder itself, which is accomplished by intersecting those two sets (5). The result from either set (3) or (5) is the set of all FileHandles for which the Value of the property should be recalculated. As a result, the algorithm iterates over that set (10), and in the body of that iteration, calculates the new value (9) and checks if the new value is different from the old value (8). If not, then the algorithm proceeds to the next file. If yes, then a ChangedFileProperty is added to the ChangeSet (7) and the value of the property in the storage (6) is updated. Additionally, the property may be added or removed from the active or visible properties of the file handle. When all files are processed the algorithm ends (11).

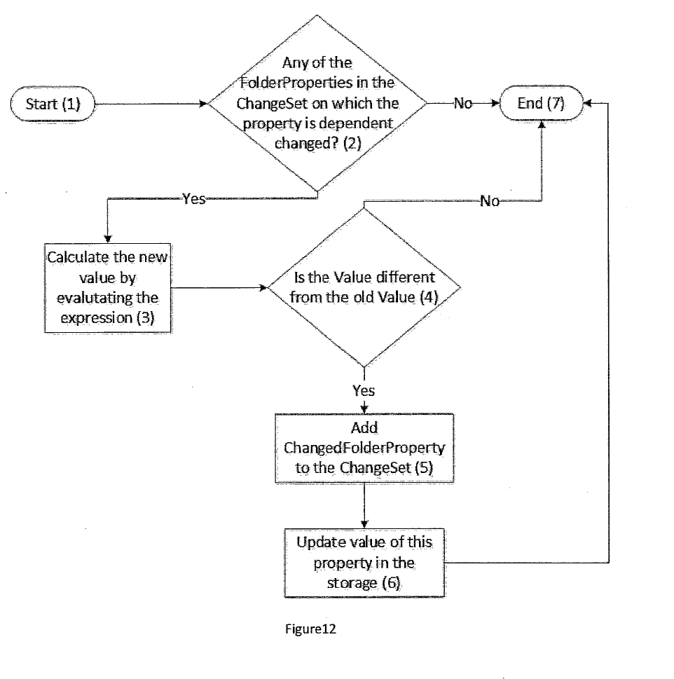

An exemplary update method of an ExpressionFolderProperty is illustrated in FIG. 12. When the algorithm starts (1), it checks if any of the FolderProperties referenced from its Expression have changed (2. If so, the new Value (3) is calculated, and the algorithm checks if the new Value is different from the old Value (4). If the new Value is different, then a ChangedFolderProperty and the old Value is added to the ChangeSet (5), and the Value of the Property in the store (6) is updated, after which the algorithm ends (7). If no FolderProperty on which it depends changes, or the new Value was not different from the old Value, the algorithms ends (7) after these steps.

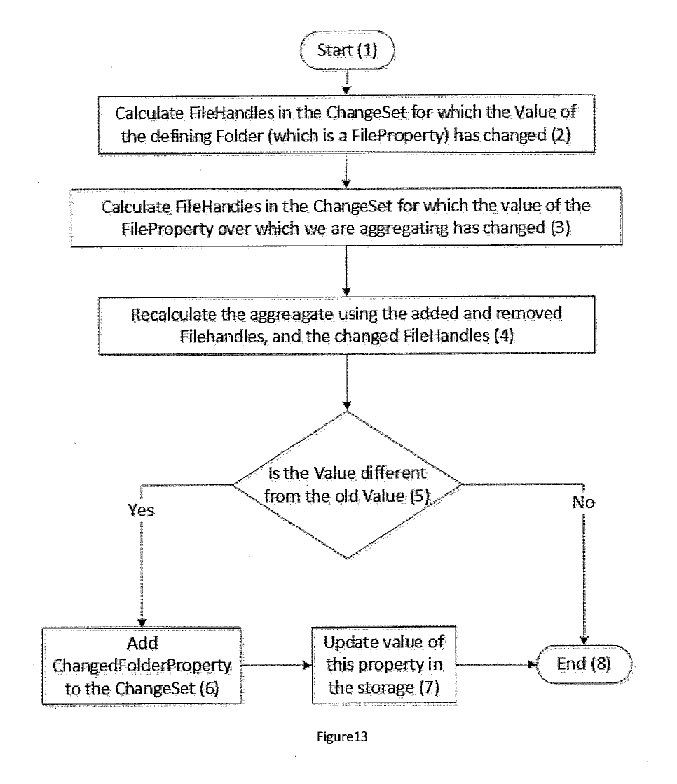

The update of an AggregateFolderProperty is illustrated in FIG. 13. When the algorithm starts (1), it asks the changeset object for all file handles that have been added or removed from its folder (2). In addition, it is possible to simultaneously ask the change set for all filehandles for which the value of the file property over which the algorithm is aggregating has changed (3). Using these two sets of information, the aggregated value can be calculated in an optimized way (4), and the algorithm can check if the value has changed (5). If it has changed, the changeset (6) and the storage (7) are updated and the algorithm ends (8). If no change has occurred, the algorithm ends directly (8).

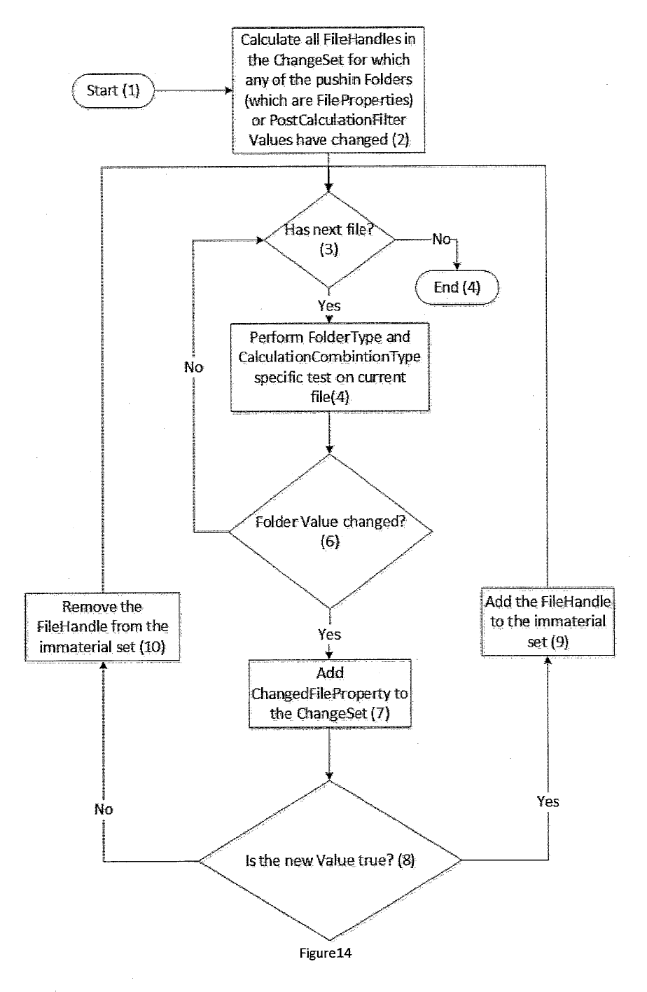

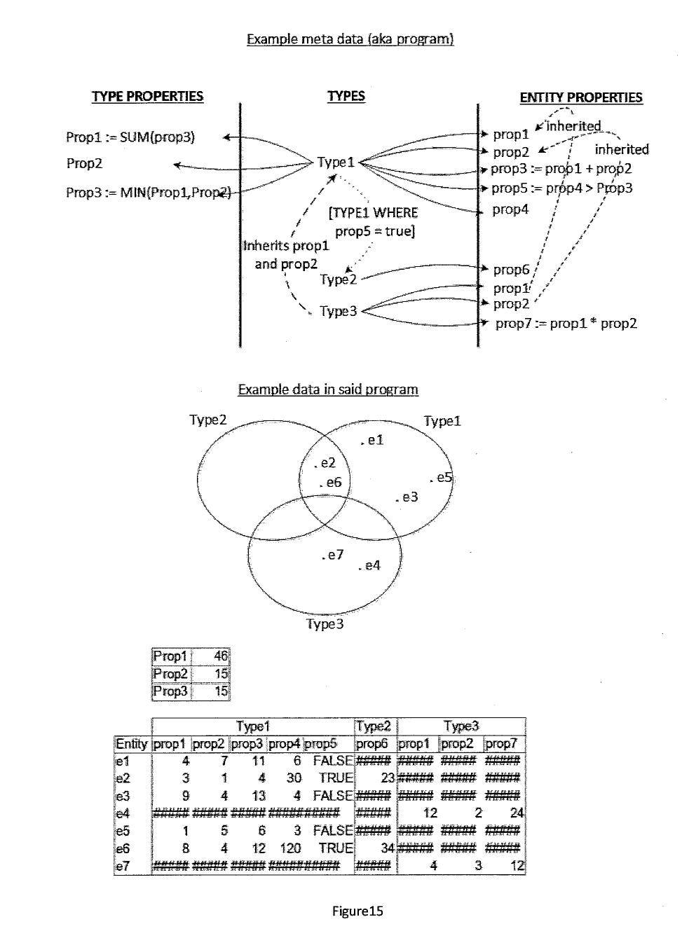

Finally, FIG. 14 shows how a folder updates the change set in its update method. The algorithm of FIG. 14 begins by getting all file-handles that have been added to or removed from the push-in folders, and also all file-handles that have changed their value for an optional condition (2). For each file (3) in this set, a test is carried out to see if the file should be present in the folder (4). The algorithm then checks the folder membership value (6) and, if possible, adds the change to the change set (7) and updates the immaterial set of the folder ((8), (9) and (10)). When all file-handles have been processed, the algorithm ends (4).

### Options, Additions, and Variations of the Exemplary File System

### Proxies

Having described a file structure and algorithms for implementing the file structure generally illustrated in FIGS. 1 and 2, those skilled in art will appreciate that numerous additional features and variations may be included without departing from the scope of the invention. Some of these features are described below, but the description is not intended to be limiting in any way.

For example, in the illustrated client/server embodiment, the client may keep proxies to objects in the server that it has an interest in. When the state of a proxyable object in the server is changed, those changes are sent to all client that have proxies of the proxyable object (preferably not directly, but at the end of each update cycle, so that the changes can be sent in bulk). The proxies then update themselves to reflect the state of their associated proxyable object on the server side. This is how the notifications reach the client. On the client, proxy objects can be ‘lazy’ loaded, meaning they will only request their data from the server when they are first accessed. The client may update the proxyable object by sending an appropriate message to them. These kinds of architectures are common in the community and many variations are known, including CORBA, RMI, REMOTING, and others.

Other embodiment may also provide a means for the client to unregister proxy objects by letting the server know that it no longer has an interest in certain server objects.

### Extensions/Additions

a) Making Computations Run in Parallel

Many of the algorithms disclosed here can be parallelized easily by, for instance, using a framework such as Plink from Microsoft.

b) Locking Elements Based on Navigational State.

When trying to update a field, the system will ensure that the values of fields on which that field is dependent still have the same values as currently shown on the screen of the user performing the modification. If the values have changed, the operation may be aborted, or the user will be alerted and asked what values the affected fields should have. This technique is known as optimistic locking and is well known in the computer industry. Alternatively, pessimistic locking may also be used.

Files may also be locked, but these mechanisms are hard to configure for the user and then specific transaction boundaries need to be set. However, these problems can be avoided by having the user prevent other users from doing certain operations by certain gestures on his screen, such as the following (listed by way of example and not limitation):

When the user has selected a folder, other users cannot delete that folder.

When the user has selected a file, other users cannot delete that file.

When the user has selected a field, other users cannot delete that field.

When the user is renaming a folder, other users cannot delete it, nor rename it.

When the user is editing a field, other users cannot delete it, nor edit it.

Those skilled in the art will appreciate that this is a kind of pessimistic locking, and that variations exist.

In the above example, the user may be given visual clues on the user's display screen as to when the user cannot perform a certain action because another user has locked the right to perform those operations.

In one embodiment the system does this by altering the visual appearance of locked elements. For example, the colors of locked elements could be altered by a color filter, the locked elements may be surrounded by a dedicated border, or an icon may be added to locked elements.

The system may also provide an easy way for the user to see which other user holds the lock. This may be done be showing the name of the other user in the vicinity of the locked element. Alternatively, a tool tip or a pop up may be shown in the vicinity of the locked element, and the system may provide an integrated chat or video conference module to allow users to communicate and ask why they are locking a certain element.

c) Contextual Notification

Contextual notification may be provided by allowing a user to choose to receive contextual notifications of field changes. In that case, the system will remember the field values that the user has seen on his screen. When the value of any of those fields is altered, the user is notified, if the contextual notification time window of the field has not yet passed.

As an example, a user may view the age field of a certain person's file, and then browse away to another file while some other user updates the already seen age field. If the update occurs with 5 minutes (the contextual time window of the age field) from the first user seeing the age field, then the first user will be notified of the change.

Fields may also have related contextual notification fields. When the value of a field is changed, and any of its related contextual notification fields have been viewed by the user within the time window of the original field, then the user will be notified of the change in the changed field. When the user navigates in the client application and is exposed to other fields or elements, the user will also be notified of the newly contextually relevant changes. Consequently, contextual notification may not only provide for notifying a first person when the first person has seen a field and then a second person modifies that same field within a certain time frame, but provide for notifying the second person when the first person modifies a field and the second person sees that same field within a certain time frame.

By correctly configuring the time-windows and related contextual notification fields, an effective concurrency conflict resolution mechanism can be built. A time-window is only one way to filter out irrelevant notifications. Another measurement of time may be the number of click done by the user, or the number of file opened by the user. These last measurements of time are relative to user activity.

d) Domains

Entities (individuals and companies) like to be in control of their data. This means that even if they choose to share files and field values thereof, they still demand that those files and field values be stored on their own systems. That way, when the entity later decides to stop sharing its data with another entity, the other entity no longer has access to their data. This creates a need for a concept that represents the data owned by an entity. That concept is known as a domain. A domain is thus the collection of files and field values owned by an entity. The main characteristic of a domain is that it has exactly one security model.

Although physically a domain may include many computing devices working together, logically the domain presents itself as one server to any client that wants to interact with it. Any client that wishes to interact with a domain will first be authenticated against to domain. Once the identity of the client has been established, the client will be authorized to perform an operation if allowed by the entity in control of the domain. A domain is thus a set of files and file fields of which the security aspects are under the control of one entity. This definition does not preclude entities from being the owner of multiple domains, or computing devices from participating in multiple domains.

This matters in the context of the present invention because files from one domain can be added to folders from other domains. These files are then foreign to that domain. When a folder adds file fields to a file, the foreign file fields may show up when looking at the file from inside the other domain, so that each folder, file and field belongs to a certain domain and is under the control of that domain and the security constraints of that domain.

e) Security Model

Another useful extension to the system is an imposed security model. In such a security model, each user of the system will have various rights. For instance, the user may be able to see only files in a certain folder, or files that meet specific conditions. In such a security model all actions that the system may perform, as well as all information that the system may show or alter, would be limited by the rights granted to the current user operating the system. The security extension may be used to grant different rights to users from different domains.

f) Folder's Relationships Visualization Tool

Another useful extension is a configuration visualization tool. This tool allows a visual representation of the relationships of folders, for example to clearly identify from which folders a folder inherits, as well as which folders a calculated folder uses as source or push-in folders. This would most likely be represented as a visual graph.

g) Data Validation

Another useful extension to the system is data validation. Data validation allows the system to limit the data that can be entered into the system, by allowing only ‘valid’ data to be entered. As an example, a valid value of an age field for a person file would be a positive integer number. A negative number would be rejected by the system.

The system may carry out the data validation by evaluating a validation function. A validation function conceptually takes as input the entire system and returns a boolean value. In other words, for any given system the validation function returns true or false. The system will not allow the user to enter data that would make the validation function evaluate to false.

The validation function may be composed of many smaller functions, for example one function for each field. These smaller function may than have an associated explanatory message that can be shown to the user, such as ‘The age field of a person must be a positive integer number.’

h) Transactions Based on a Data Validation Extension

Two useful extensions related to the data validation extension are those of transactions and isolation. These two concepts are borrowed from the database world and have similar semantics in this system.

Isolation makes it appear to a user as if the user were working on the system alone, although the user may in reality be sharing the system with many other users. This means that the changes made by other users are not visible to the user until the changes have been committed, while the user's changes are also not visible to other users until the user has committed his or her changes.

Transactions are a set of changes that are atomic, i.e., that are treated as if they are only one big change rather than multiple changes, and that that may be completely accepted or completely rejected by the system. In some embodiments, the user may only commit changes when there are no validation errors. In order to be able to validate the changes, the system may have to be able to perform all data updates locally on the client. Similarly to when the system is used offline, this implies that all server functionality must also be present on the client.

i) Human Error Reduction System

Another useful extension is human error reduction. Humans make mistakes. This means a user may read a certain number (five) from a document, but incorrectly enter another number (six) into an associated input field. To help guard against human error, whether intended or not, the system may require a level of redundancy. This means that the system will only accept data if the data has been consistently entered independently by two or more users. In the example provided, the system would not accept the value six, because the other user that must independently enter the same data will not have entered six, but five. Thus the system will have detected the human error and may take appropriate action, such as requesting that both users enter the value again.

j) Views

Yet another useful extension to the system is views. Views deal with localisation and customization of the system to specific users and usage scenarios. Localization entails that the folders' names are translated to the culture of the viewer. For example, the folder ‘Houses,’ defined by an English speaking user, would be displayed as the folder ‘Casas’ to a Spanish speaking user. The system will have to maintain translation tables and other data in order to accommodate the different wording.

The preferred language of the user, as well as number formats, currencies, and other culture dependent aspects are maintained in the profile of the user. The profile may also specify which folders and fields the user is most interested in and which he would like to be hidden. The profile of a user may be within or outside the user's control or a combination thereof. Views may even alter the hierarchy of folders and be conditionally activated based on the current values of certain fields.

k) Audit Trail

Another useful extension to the system is an audit trail. All actions performed by a user, as well as any data altered by the user will be recorded so that other persons may later see who altered the value of a field or executed any other operations.

l) Actions

Another useful extension to the system is actions, which allow the system to execute various actions at certain hook points. For instance, in response to the changing of the value of a field of a file, the system may send an email to a certain person or perform some other action, such as sending a text message (SMS), sending a message to another system, updating or inserting a row in a database, or even printing the associated document. Other useful hook points may be provided such as performing an action when a file is added to a folder or removed from it. One special hook point may be the passing of time, so that certain actions will be performed periodically. Third parties can supply their own actions through extension API's.

m) Extension API's

Another useful extension to the system is a way for third parties to integrate with the system through extension application programming interfaces (API's). The system will expose various API's in various languages, including but not limited to c#, VB, Java and c++. Through these API's, entities and third parties can create extensions to the system, which they can sell and distribute through an integrated extension distribution system.

n) Plug-Ins

Another useful extension would be that of a plug-in architecture. Third parties may implement modules that can be integrated with the system. These plug-ins can be distributed to the possible client through an integrated plug-in system, and can also be sold to the client for a fee. Part of this fee may be transferred to the submitter of the purchased plug-in. Besides plug-ins, a submitter may also submit configurations of the system, such as predefined folders and fields, that may be integrated with the plug-in.

o) Reporting

Another useful extension to the system is a reporting facility. This extension allows users to distil reports from the data contained within the system. The reporting facility will generate textual documents, spreadsheet files, web pages and other artefacts that the user may find useful.

p) Versioning

Another useful extension to the system is versioning, which allows users of the system to see not only the files and fields with their current values, but also to see them as they were at a previous point in time and possibly restore those previous versions.

q) Representing files and folders as pages

Another useful extension is that both a folder and a file may present themselves as ‘pages,’ where a page is similar to a web page, but instead of coming from the web, the pages originate locally or from a foreign file flow server and may use a different mark-up language. Such a page may embed text, images, video, animation and any other type of multimedia, as well as calculated fields, forms and action buttons in between various visual and other sensory elements. In addition, the page may contain links and integrate with the existing web, including links to web pages and their content, so as to generate web content from the content in the system.

r) Embedded a Web File Server

Another useful extension to the system is an integrated web server, which allows the system to serve web pages built from the content into system. Additionally, an embedded email client and server may be used to allow the system to send and receive emails, and the client may also have an integrated web browser. Furthermore, the system may include an integrated search engine that allows users to search for files and field data across all fileflow systems in the world.

s) Search

Another useful extension to the system is a search facility. The user may search for a certain string across all files in all folders, and their associated fields. When the file name, its description, its content or one of its fields match the given search criteria, it is added to the results that will be returned to the user. This works similarly to how a web search engine searches for web documents to present to the user when the user enters search criteria. A search may of course be limited to a folder.

Another type of search that the user may perform is a structured search. In a structured search, the user will specify certain criteria for certain file fields of a folder and will be presented with all files in that folder that match the criteria. This allows the user to quickly find, for example, all customers older than 40 in the folder ‘Customers,’ by specifying ‘Age>40’. This works similarly to how databases search for records to present to the user when the user enters search criteria.

t) Integration Modules and Native File Associations

Another useful extension is to include various integration modules to allow tight integration with the file systems currently in use on various operating systems, including but not limited to Windows™, Mac OS X™ and all Unix™ and Linux™ flavours. More specifically, the integrations modules will allow tight integration into the file explorers used on these systems, including but not limited to: Windows Explorer™ and Mac Finder™. In addition, tight integration with the desktop modules offered on those operating systems, as well as with their registry modules and peripheries, may be provided.

A related extension is the use of native programs and native file associations. Because the system manages files, the user must be able to open these files in a program designed to deal with that specific type of file. Various operating systems have various ways of associating files with the corresponding programs that can open and edit them. These integrations will allow the user to use a system without being aware of the fact that the user is using the system.

Integration modules may also allow tight integration with various database systems such as relational, hierarchical or object oriented systems, including but not limited to MySql, SQL Server and Oracle.

u) Integrations with Screen Readers and Assistive Technologies

The invention can be extended with screen readers and assistive technologies.

v) Integration of Geographical Data

The invention may be extended by attaching geographical information to added files. For instance, when a user takes a picture that is immediately imported to the system, the location may be attached to it.

w) Data Mining Functionality or Data Analytics

The invention may be extended by including data mining functionality that will search for patterns in the field and files, or data analytics and statistics functionality. For example, statistics can be kept about how many times a file is accessed, what key words that most queries contain, and so forth, similar to the analytics provided by web frameworks. This is useful to gain insights into how the user uses the system and into the system's performance.

x) Transaction Modes

Transaction modes can be easily added by leveraging them from the particular persistence solution used in the system.

y) Offline Availability

Offline availability can be added by letting the client synchronize with the server when the client connects to the server. In order to do this, the server may contain a log of all updates that have been performed by it. The client contains that same log, although it may be outdated and thus not contain the latest changes. When the client connects, it downloads the missing changes and then sends its locally performed changes to the server. This technique is well known and some persistence solutions provide for it out of the box.

z) Archiving System

The invention can be extended with archiving functionality by allowing it to integrate with a scanner. The user can then scan all of the user's documents, with the scanner adding a code to each scanned document or the code being added manually by the person that is performing the scans or by a separate printer. This code is then used to link the file with its physical document. The code may include a hierarchy such as cabinet, box, stack and page number.

aa) Payment Module

The invention may be extended with a payment module, allowing among other things the user to pay his invoices directly through the system, order plug-ins and pay for services.

ab) Services

The invention may be extended with a service model according to which a user may buy services from third party vendors through an integrated service selling system. The services may include filling in the file properties of files, categorising the files in folders, and providing advice to the user. This would enable the user, among other things, to let his accounting be done by a third party. It may also allow service providers to advise the users about such items as the utilities they use (gas, electricity, and so forth). The service providers could then make the users a better deal by providing a packet of utilities at a better price. They could also negotiate with the service providers on the users' behalf.

ac) Using Compression Techniques

Finally, another useful extension is the use of compression techniques to store files and to transfer them. When the receiving party of a file sending operation already has a previous version of the file to receive, and the sending party also has access to this previous version of the file, then the sending party may send only the difference between the version that the receiving party already has and the requested version (possibly the newest version). This may save a lot of bandwidth and be faster.

Also, since many file systems contain the same file many times (perhaps because the user is sloppy and lets copies of files lying around), the file system may reuse a part of the bytes from one file in another file. For instance, all files may be chopped up in smaller parts, say of 1 kilobyte. Files may then be stored as a collection of file parts. The advantage of this way of storing files is that similar files may share many of their parts, leading to lower storage requirements.

Similar files may include (possibly modified) copies of the same file, or different versions of a file.

These two techniques may be combined to lead to a faster and less resource demanding system.

### Variations for Terminology Used in the Above Description

For practical reasons, the above description describes the invention by using certain terms that will be understood by those skilled in the art to have a broader meaning in the context of the invention.

For example, as noted above, the word “file” means the file or a link there to, unless stated otherwise. Similarly, as explained above, the invention is intended to apply to objects and other data entities rather than just ‘files.’ When the invention is used with empty files, it may be considered to be a system for working with objects in an adapted object oriented system. Alternatively, all files may be replaced with objects with one extra field containing the data in the file. This is why the current invention can be seen as a file system or an object management system. Indeed, files can be seen as objects, and folders can be seen as a new kind of dynamic classes of these objects. File properties and folder properties would then be some kind of self calculating very high level instance and static fields. Still further, the words ‘property’ and ‘field’ may be interchanged, as they often are within the programming community, while the “if” statement of conditionally executing code may be represented by use of a switch with cases, a polymorphic call, or branching instruction. Additionally, the words ‘entity property’ and ‘file property’, and the words ‘type property’ and ‘folder property’ may be interchanged.

The linking of pieces of data, i.e., establishing relationships, may be expressed or described in a variety of ways. The most trivial way to link data is through pointers in contained in arrays, structs or classes, possibly contained within data structures of some kind such as arrays, lists, hash sets, tree structures, heaps and many more. Pieces of data may also be linked by transitivity, dereferencing multiple pointers sequentially. Another popular way to link data is through keys. A key is a piece of data that allows the holder of that data to use that data to uniquely locate another piece of data, such as a pointer or an object or struct. Keys are usually integers or combination of integers. Dictionaries (a.k.a. associative arrays) are also a popular way the link pieces of data. All these methods are equivalent ways to realize an association or relationship between computing entities, and are to be included in the concept of ‘association’ or ‘linking’ utilized by the invention. In addition, those skilled in the art will appreciate that when two classes have an association, one needs to refer to the other, but it does not matter where that link is stored. The link may be stored at each side of the association, at both sides, or in an external lookup system. Any person skilled in the art can easily alter the place where the actual links are stored.

Similarly, the representations of algorithms included herein may, by way of example and not limitation, be modified by inlining, which involves moving conditional code up the stack: When a function is inlined, the code of that function is now used solely in the context of the containing method. This often allows the code to restructured to be more optimal for that specific context. It is well known to those skilled in the art that code can be structured to do more reuse by introducing functions, often with parameters that allow the function to fit its behavior to that needed in the calling context, or that functions can be inlined, reducing the level of abstraction and reuse but allowing local optimizations. An example of this is moving conditional code outside of the loop, by putting the condition on top and duplicating the loop. Similarly pieces of data that are recomputed each cycle of the loop but always return the same value may be moved outside of the loop. Skilled programmers can easily alter between these representations of an algorithm. Alternatively or in addition, loops may be replaced by using recursive functions rather than loops.

The fact that an element is contained in a set (such as a folder) may be expressed in two equivalent ways: a boolean can be added to the class of the element that may be stored in the set, in which the boolean then represents its possible containment (if its value is true, than the element belongs to the set, if it is false, than it does not), or a set data structure may be used that may or may not contain the element. These two ways of storing containment may be considered to be equivalent. In fact each representation is an index over the other. A set is simply a faster way to find all elements how's boolean value is true and a boolean is simply a faster way to check if the element is contained in the set. Similarly, each value of an enum has an associated set. This is why, as noted above, folders may be understood as boolean properties of files. If its value is true, than the file belongs to the folder, if it is false then it does not. Some embodiments may choose to include files for which the value is unknown, other may exclude those files. This value may be calculated or not. Reference to a folder as a folder membership property simply emphasizes that the folder is also a file property and is very similar to ‘normal’ expression file properties.

Other changes in representations that may be applied to the above description include changes in the order of steps that are not dependent on each other, using subclasses, or adding extra fields to a class. These and a multitude of various techniques can be employed by any programmer skilled in the arts to make various variations of the same algorithm or system. All programming samples, diagrams and disclosed algorithms provided in this document represent their present form, as well as all variations that may be formed from them by using the above mentioned techniques.

Additional Non-Limiting Examples of Alternative Versions of Terminology Used Above:

Examples of generally known output devices for human receivers are:
A sound generating device, such as for example earplugs or speakers, . . . .
A display device, such as a computer display, laptop display, tablet display, smartphone display, watch display, projector, eye lens or contact lens display device, which is a device optimized to be worn on the surface of the eye of a human being, eyeglass display, which is a display device optimized to be worn in front the eye of a human being, etc.

Examples of generally known output devices optimized for non-human receivers, such as for clients or servers or standalone computing devices, are a Modem, USB port, Serial port, Parallel port, Ethernet port, optical port, wireless communication device, any other electrical based communication device, any other Light based carrier communication device, etc.

Examples of generally known input devices for capturing human generated input are a sound input device such as for example a microphone, touch input device such as for example a touchscreen or touch pad; pointer input device such as for example:
a mouse,
an eye motion tracking device,
a computer vision device, for example a body motion tracking device; and
a neural communication device which is a device optimized to interact directly with the brain of a human, etc.

Examples of generally known input devices optimized for capturing input generated by a non-human are a modem, USB port, Serial port, Parallel port, Ethernet port, Optical port, wireless communication device, any other electrical based communication device, any other light based carrier communication device, etc.

Examples of generally known calculating devices are: a central processing unit (CPU), a desktop computer, a laptop, a web browser application, a watch, a smartphone, a tablet computer, etc.

Examples of a data entity are for example a file, an object oriented data structure, database records, etc.

According to a still further embodiment, the set of data entities contained in an extent may be different in different contexts. The context, which may for example be the current opened data set, the current user, the current version or any other suitable selectable information, enables the current content of the extent to be uniquely identified. According to such an embodiment the entity properties and type properties have suitable values for each of the available contexts.

In general, when a value of a property is referred to, the value of the property may be a number. However, some embodiments may also allow the value of a property to be UNKNOWN or NULL, a default value, or a default value configured per property, and that these special values are thus also values.

When referring to a subset in the description, the term ‘subset’ is used in the following sense: a first set is a subset of a second set when said first set contains between zero and all elements of said second set and said first set does not contain any elements not contained by said second set.

According to an embodiment of the invention the navigational state of a program is that part of the internal state of the program that influences the subset of data that is being displayed by an associated display device. A navigational state is often reached by repeatedly instructing the program to display the details of a data entity, by selecting said data entity.

Having thus described preferred embodiments of the invention in connection with the accompanying drawings, it will be appreciated that the invention is not to be limited to the specific embodiments or variations disclosed, but rather should be limited solely by the appended claims.

I claim:

1. A data system comprising at least one type stored in a computer readable storage,
said type comprising associated properties consisting of entity properties and type properties,
said type having a value for each of said associated type properties and
said type further comprising an associated extent,
said associated extent consisting of a set of all data entities which are an instance of said type,
each of said data entities of said extent having a value for each entity property associated with said type, and
said data system further comprising a calculating device configured to:
derive the values of said associated properties by a property calculation based on the values of other associated properties and
derive the set of all data entities of said extent by an extent calculation
wherein said data entities have an associated set of extents to which they belong.

2. The data system according to claim 1, wherein said associated set of extents to which a data entity belongs is calculated by extent calculations and may change over the lifetime of said data entity; and
wherein said extent calculations include at least a comparative evaluation of a test value, said test value being the value of an entity property of all data entities of at least one other extent.

3. The data system according to claim 2, wherein the available operations of said property calculations for entity properties include at least one of:
a summation, a subtraction, a division or a multiplication performed on said other associated properties for entity properties, which include entity properties of said type or type properties of other types; and
aggregation calculations performed on all values of an associated entity property of all data entities of the extent of said type.

4. The data system according to claim 1, wherein said type inherits the entity properties of another type.

5. The data system according to claim 3, wherein said type inherits the entity properties of another type.

6. The data system according to claim 3, wherein the calculating device is further configured to automatically recalculate:
said property calculations in response to a change in said values of other associated properties;
said extent calculations in response to a change in said test values; and
said extent calculations in response to a change in said at least one other extent.

7. The data system according to claim 3, wherein a data entity is part of the extent of a first type, the first type having a first associated entity property deriving its value by means of a first property calculation; and the data entity is also part of the extent of a second type, the second type inheriting said first associated entity property from said first type, wherein the second type overrides the first property calculation by a different second property calculation such that when said data entity is part of the extent of said second type, the value of said first property of said data entity is calculated by said second property calculation.

8. The data system according to claim 6, wherein a data entity is part of the extent of a first type, the first type having a first associated entity property deriving its value by means of a first property calculation; and the data entity is also part of the extent of a second type, the second type inheriting said first associated entity property from said first type, wherein the second type overrides the first property calculation by a different second property calculation such that when said data entity is part of the extent of said second type, the value of said first property of said data entity is calculated by said second property calculation.

9. The data system according to claim 3, wherein said data system further comprises a display device and an input device, at least one of said types has an associated set of child types, forming a hierarchy, said display device is configured to display said hierarchy, and said input device being configured to allow a user to navigate through said hierarchy in order to select a type.

10. The data system according to claim 6, wherein said data system further comprises a display device and an input device, at least one of said types has an associated set of child types, forming a hierarchy, said display device is configured to display said hierarchy, and said input device being configured to allow a user to navigate through said hierarchy in order to select a type.

11. The data system according to claim 3, wherein said calculating device is formed as a collaborative system comprising a plurality of computing nodes connected by means of a communication network, such that said computing nodes form a server and client architecture with a server and one or more clients, said computing nodes functioning as a client comprising an output device, wherein changes to said values of said associated properties lead to said server sending notifications to a subset of all clients connected to said server, and wherein in response to said notifications, said clients alter the output of their respective output devices.

12. The data system according to claim 6, wherein said calculating device is formed as a collaborative system comprising a plurality of computing nodes connected by means of a communication network, such that said computing nodes form a server and client architecture with a server and one or more clients, said computing nodes functioning as a client comprising an output device, wherein changes to said values of said associated properties lead to said server sending notifications to a subset of all clients connected to said server, and wherein in response to said notifications, said clients alter the output of their respective output devices.

13. The data system according to claim 12, wherein at least one of said clients comprises an input device configured to at least enable modifications of said associated properties of said type, said modifications include:
altering the property calculation of one of said associated entity properties followed by
altering the extent calculation of one of said types,
wherein said server is configured to process said modifications of said associated properties originating from said client.

14. The data system according to claim 13, wherein said modifications are processed without any other clients having to log in or out again.

15. The data system according to claim 13, wherein said modifications are processed without any other clients losing navigational state.

16. The data system according to claim 3, wherein said calculating device is formed as a standalone system comprising a single computing node comprising an output device, wherein changes to said values of said associated properties lead to said standalone system altering the output of its output device.

17. The data system according to claim 6, wherein said calculating device is formed as a standalone system comprising a single computing node comprising an output device, wherein changes to said values of said associated properties lead to said standalone system altering the output of its output device.

18. The data system according to claim 17, wherein the standalone system further comprises an input device and the output device is a display device configured to:
display said type;
display the data entities in the extent of said type upon selection of said displayed type through said input device; and
display the values for a subset of said associated entity properties of a displayed data entity upon selection of said displayed data entity.

19. The data system according to claim 18, wherein said display device is further configured to modify the display state of said displayed associated entity properties of said displayed data entity in function of the extents of which said displayed data entity is part of.

20. The data system according to claim 18, wherein said data system is configured to at least enable modifications of said associated properties of said type, said modifications comprising of altering the property calculation of one of said associated entity properties followed by altering the extent calculation of one of said types, and wherein said standalone system is configured to process said modifications of said associated properties.

21. The data system according to claim 19, wherein said data system is configured to at least enable modifications of said associated properties of said type, said modifications comprising of altering the property calculation of one of said associated entity properties followed by altering the extent calculation of one of said types, and wherein said standalone system is configured to process said modifications of said associated properties.

22. The data system according to claim 20, wherein the processing of said modifications of said associated properties does not require the restart of one of the processes running on the standalone system.

23. The data system according to claim 20, wherein the processing of said modifications of said associated properties does not cause said standalone system to lose its navigational state.

24. The data system according to claim 21, wherein the processing of said modifications of said associated properties does not cause said standalone system to lose its navigational state.

25. The data system according to claim 6, wherein the available operations of said extent calculations include at least the union and intersection of one or more other extents; the available operations of said aggregation calculations include at least calculating the minimum, maximum and summation of said values; and the available operations of said property calculations for said associated entity properties further include at least smaller than, bigger than and equal to.

26. The data system according to claim 15, wherein the available operations of said extent calculations include at least the union and intersection of one or more other extents; the available operations of said aggregation calculations include at least calculating the minimum, maximum and summation of said values; and the available operations of said property calculations for said associated entity properties further include at least smaller than, bigger than and equal to.

27. The data system according to claim 23, wherein the available operations of said extent calculations include at least the union and intersection of one or more other extents; the available operations of said aggregation calculations include at least calculating the minimum, maximum and summation of said values; and the available operations of said property calculations for said associated entity properties further include at least smaller than, bigger than and equal to.

28. The data system according to claim 15, wherein said type inherits the entity properties of another type.

29. The data system according to claim 23, wherein said type inherits the entity properties of another type.

30. The data system according to claim 25, wherein said type is a folder, said data entities are files, and said extent is a set of files associated with said folder.

31. The data system according to claim 26, wherein said type is a folder, said data entities are files, and said extent is a set of files associated with said folder.

32. The data system according to claim 27, wherein said type is a folder, said data entities are files, and said extent is a set of files associated with said folder.

33. The data system according to claim 25, wherein said type is an object base programming structure, said data entities are instance of said object based programming structure, and said extent is a set of instances associated with said object based programming structure.

34. The data system according to claim 26, wherein said type is an object base programming structure, said data entities are instance of said object based programming structure, and said extent is a set of instances associated with said object based programming structure.

35. The data system according to claim 27, wherein said type is an object base programming structure, said data entities are instance of said object based programming structure, and said extent is a set of instances associated with said object based programming structure.

36. A server for use in the data system according to claim 31.

37. A server for use in the data system according to claim 34.

38. A client for use in the data system according to claim 31.

39. A client for use in the data system according to claim 34.

40. The data system according to claim 15, wherein said at least one client comprises a display device and an input device, at least one of said types has an associated set of child types, forming a hierarchy, said display device is configured to display said hierarchy, and said input device being configured to allow a user to navigate through said hierarchy in order to select a type.

41. An object-oriented development system for creating a computer program that is suitable for use by an by agent, said computer program comprising types with associated type properties and associated entity properties collectively referred to as the associated properties of a type, wherein for each such type:
said type has a value for each of said associated type properties and
said type has an associated extent, said associated extent consisting of a set of all data entities which are an instance of said type,
wherein each of said data entities of said extent has a value for each entity property associated with said type and said agent is a user or computer process, said object-oriented development system comprising:
a calculating devices configured to:
derive the values of said associated properties by a property calculation based on the values of other associated properties and
derive the set of all data entities of said extent by an extent calculation; and
a machine-readable medium embodying information indicative of instructions executable by said calculation device, said instructions comprising:
instructions for defining and a first type upon the agent's request, said type being configured to enable agents to add data entities to and remove data entities from the extent of said first type;
instructions for defining a first entity property associated with said first type upon the agent's request, configured to enable agents to alter at least one value of said first entity property;
instructions for defining a second entity property associated with said first type upon the agent's request, configured to enable agents to alter at least one value of said second entity property;
instructions for defining a third entity property associated with said first type upon the agent's request, configured to have as value the summation of the value of said first entity property and the value of said second entity property; and
for each data entity contained in the extent of said first type:
instructions for defining a first type property associated with said first type upon the agent's request, configured to have as value the summation of the values of said third entity property of all data entities in the extent of said first type;
instructions for defining a second type property associated with said first type upon the agent's request, configured to enable agents to alter at least one value of said second type property;
instructions for defining a third type property associated with said first type upon the agent's request, configured to have as value the minimum of the value of said first type property and the value of said second type property;
instructions for defining a fourth entity property associated with said first type upon the agent's request, configured to enable agents to alter at least one value of said fourth entity property;
instructions for defining a fifth entity property associated with said first type upon the agent's request, configured to have a boolean value that indicates if the value of said fourth entity property is bigger than the value of said third type property; and
for each data entity contained in the extent of said first type:
instructions for defining a second type upon the agent's request, configured so that its extent contains all data entities contained in the extent of said first type for which the value of said fifth entity property is true;
said system further including:
an input device configured to at least
receive input that causes said calculating device to alter the value of said first property for a data entity; and
receive input that causes said calculating device to output the value of said first property for a data entity by means of an output device; and
an output device configured to at least
output said value of said first property in response to said input that causes said calculating device to output the value of said first property for a data entity.

42. The object-oriented development system according to claim 41, wherein said instructions further comprise:
instructions for defining a sixth entity property on said second type upon the agent's request, configured to enable agents to alter at least one value of said six data entity property; and
wherein said output device is a display device and is configured to:
display a subset of said types;
display the data entities in the extent of data entities of a displayed type upon selection of said displayed type through said input device;
display the values for a subset of said associated entity properties of a displayed data entity upon selection of said displayed data entity; and
modify the display state of said sixth entity property for a data entity in function of said data entity being a part of the extent of said second type.

43. The object-oriented development system according to claim 42, wherein said instructions further comprise:
instructions for defining a third type upon the agent's request, configured to enable agents to add data entities to and remove data entities from the extent of said third type;
instructions for letting said third type inherit said first and second entity properties of said first type upon the agent's request;
instructions for defining a seventh entity property associated with said third type upon the agent's request, configured to have as value the multiplication of the value of said inherited first entity property; and
the value of said inherited second entity property for each data entity contained in the extent of said third type.

44. A method for automatically updating the values of derived properties in a data system, wherein:
said data system comprises at least one type stored in a computer readable storage,
said type comprises associated properties consisting of entity properties and type properties,
said type has a value for each of said associated type properties,
said type further comprises an associated extent, said associated extent consisting of a set of all data entities which are an instance of said type, each of said data entities of said extent having a value for each entity property associated with said type, and
said data entities have an associated set of extents to which they belong,
wherein said data system further comprising a calculating device executing the following one of the following sequences of steps:
deriving the values of said associated properties by a property calculation based on the values of other associated properties;
deriving the set of all data entities of said extent by an extent calculation that associates a test value with each data entity in at least one other extent based on at least one entity property associated with the type of said at least one other extent;
automatically recalculating said property calculations in response to a change in said values of other associated properties;
automatically recalculating said extent calculations in response to a change in said least one other extent; or
in said at least one entity property associated with said at least one other extent, causing a change in said test value; and
automatically recalculating said extent calculations in response to a change in at least one other extent.

45. The method according to claim 44, wherein said data system is suitable for use by an agent, and said agent is a user or computer process; and wherein said calculation device additionally executes the following steps, in response to a change performed by an agent of the value of an entity property of a certain data entity:
(a) creating an empty change set, said change set being a data structure to which change structures are added and from which change structures are retrieved, said change structures encapsulating a change in the value of a property or extent by:
for entity properties, including a reference to the changed data entity and a reference to the changed entity property, together with the new value and optionally also the previous value;
for type properties, including a reference to the changed type property together with the new value and optionally also the previous value; and
for extents, including a reference to the extent and the data entity;
(b) adding the initial change structure to said change set, said initial change structure encapsulating the change performed by said agent; and
(c) updating the values of all dependent properties and extents of said entity property in topological order by, for each dependent property or extent:
(c-1) retrieving the change structures encapsulating the changes of all the properties and extents which are referenced from the property calculation or extent calculation in order to derive the value of said property or the content of said extent, out of said change set;
(c-2) iterating over each retrieved change structure and updating the values of the entity property or type property or the content of an extent, in an incremental way by:
for an entity property calculation, recalculating the new value based on the new values of the other associated properties, for each data entity whose other associated properties have changed, thus resulting in a change of the value of said entity property for said data entity
for a type property calculation, recalculating the new value based on the new values of the other associated properties; or
alternatively in case of an aggregation that is dependent on the value of a specific entity property of all data entities in an extent, for each data entity for which said specific entity property changed,
updating the aggregation by applying the inverse of the used aggregation operation to the aggregated value using the old value of the change structure, and
updating the aggregation by applying the used aggregation operation to the aggregated value using the old value of the change structure; or additionally, for data entities added to or removed from said at least one other extent:
updating the aggregation by applying the inverse of the used aggregation operation to the aggregated value using the current value of the data entity of the change structure, and
updating the aggregation by applying the used aggregation operation to the aggregated value using the current value of the data entity of the change structure, thus resulting in a change of the value of said type property; and
for an extent calculation:
recalculating the test value for each data entity whose least one entity property associated with said at least one other extent changed;
removing the data entities whose value of said test value has become false; and
adding the data entities whose value of said test value has become true, and
additionally, for data entities added to or removed from said at least one other extent:
removing the data entity from said extent if it is no longer part of the said at least one other extent; and
adding the data entity from said extent if it has become part of the said at least one other extent and has a positive test value, thus resulting in a change for each data entity that had been added or removed to said extent;
(c-3) adding all created changes in step (c-2) to said change set.

46. The method according to claim 45, wherein parts of the automatic recalculations are not done incrementally.

47. The method according to claim 46, wherein
the available operations of said property calculations for entity properties include at least a summation, a subtraction, a division or a multiplication, performed on said other associated properties for entity properties, which include entity properties of said type or type properties of other types; and
the available operations of said property calculations for type properties include at least a summation, a subtraction, a division or a multiplication performed on said other associated properties for type properties, which include type properties of said type or type properties of other types.

48. The method according to claim 47, wherein
said property calculations for type properties further include aggregation calculations performed on all values of an associated entity property of all data entities of the extent of said type.

49. The method according to claim 46, wherein said calculation device additionally executes the following step, in response to a change performed by an agent of the value of an entity property of a certain data entity:
(d) sending all created changes to said agent.

50. The method according to claim 48, wherein said calculation device additionally executes the following steps, in response to a change performed by an agent of the value of an entity property of a certain data entity:
(d) sending all created changes to said agent.

51. The method according to claim 50, wherein
said data system is suitable for use by an agent, and said agent is a user or computer process; and
said calculation device additionally executes the following step, in response to an agent adding a type property, said type property being configured to be an aggregation of the values of an entity property for each entity in an extent, said aggregation being a summation; and
calculating the summation by summing all values of said entity property for each entity in said extent.

52. A machine-readable medium containing information, said information comprising model data for use by a data system,
said data system being able to process said model data,
said data system additionally being able to process a data set,
said data set being associated with said model data,
said model data comprising at least one type data structure such that after said data system has processed said model data and said data set, said data system comprises at least one type corresponding to said one type data structure, wherein:
said type in said data system comprises associated properties consisting of entity properties and type properties;
said type in said data system has a value for each of said associated type properties;
said type further comprises an associated extent,
said associated extent consists of a set of all data entities which are an instance of said type, each of said data entities of said extent having a value for each entity property associated with said type;
said data entities have an associated set of extents to which they belong; and
said data system further comprises a calculating device configured to:
derive the values of said associated properties by a property calculation based on the values of other associated properties, and
derive the set of all data entities of said extent by an extent calculation,
said type data structure comprising:
information for locating associated entity property data structures, representing the entity properties associated with said type;
information for locating other type data structures, representing the types from which said type inherits properties;
information for storing an extent calculation, comprising information for locating at least one other type data structure, said other type data structure representing at least one of the types that are used in said extent calculation;
said entity property data structure comprising,
information for storing a property calculation, comprising information for locating at least one other entity property data structure
said data set comprising:
the data entities;
the values of type properties;
the values of entity properties, one for each of said data entities; and
the content of the extents of types in said model data, and
wherein said locating is carried out by one of (a) a pointer, said pointer being a direct or indirect address into the computer readable medium, and (b) a unique key, said unique key being stored in the locating data structures and allowing the address of the located data structures to be determined.

53. The machine-readable medium according to claim 52, wherein types may inherit from each other.

54. A non-transitory computer readable medium having stored thereon an instruction set for enabling a client to communicate with a server,
said client and server forming a data system realized in a collaborative system comprising a plurality of computing nodes connected by means of a communication network,
a subset of said plurality of computing nodes functioning as clients comprising an output device, said client being one of said clients, and at least one of said plurality of computing nodes being said server, such that said server and said client form a client server architecture,
wherein changes to said values of said associated properties lead to said server sending notifications to a subset of all clients connected to said server, and wherein in response to said notifications, said clients alter the output of their respective output devices,
wherein said collaborative system forms a data system having at least one type stored in a computer readable storage,
said type comprising associated properties consisting of entity properties and type properties,
said type having a value for each of said associated type properties, and
said type further comprising an associated extent,
wherein said associated extent consists of a set of all data entities which are an instance of said type, each of said data entities of said extent having a value for each entity property associated with said type, and said data system further comprising a calculating device configured to:
derive the values of said associated properties by a property calculation based on the values of other associated properties, and
derive the set of all data entities of said extent by an extent calculation,
wherein said data entities further have an associated set of extents to which they belong,
wherein said associated set of extents to which a data entity belongs is further calculated by extent calculations and may change over the lifetime of said data entity,
wherein said extent calculations further include at least a comparative evaluation of a test value, said test value being the value of an entity property of all data entities of at least one other extent,
wherein the available operations of said property calculations for entity properties further include at least one of:
a summation, a subtraction, a division or a multiplication performed on said other associated properties for entity properties, which include entity properties of said type or type properties of other types; and
aggregation calculations performed on all values of an associated entity property of all data entities of the extent of said type,
wherein the calculating device is further configured to automatically recalculate:
said property calculations in response to a change in said values of other associated properties;
said extent calculations in response to a change in said test values; and
said extent calculations in response to a change in said at least one other extent,
wherein at least one of said clients comprises an input device configured to at least enable modifications of said associated properties of said type, said modifications include:
altering the property calculation of one of said associated entity properties followed by
altering the extent calculation of one of said types, wherein said server is configured to process said modifications of said associated properties originating from said client, and
wherein further wherein said modifications are processed without any other clients losing navigational state.
